(19) United States
(12) Patent Application Publication
(10) Pub. No.: US 2026/0330532 A1
(43) Pub. Date: Oct. 22, 2026

(54) INTELLIGENT SEARCH AND CONTENT CREATION PLATFORM

(71) Applicant: Constellation Software Inc., New York, NY (US)

(72) Inventors: Mohammed Nauman Hafiz, Brooklyn, NY (US); Matt Woodruff, Brooklyn, NY (US); Diana Lee, New York, NY (US); Mohammed Yusuf Khan, Calgary (CA)

(73) Assignee: Constellation Software Inc., New York, NY (US)

(21) Appl. No.: 19/545,728

(22) Filed: Feb. 20, 2026

Related U.S. Application Data
(60) Provisional application No. 63/761,431, filed on Feb. 21, 2025.
(60) Provisional application No. 63/809,698, filed on May 21, 2025.

(51) Int. Cl. G06Q 30/0601; G06F 16/242; G06F 16/248

(52) U.S. Cl. CPC G06Q 30/06311; G06F 16/243; G06F 16/248

(57) ABSTRACT

An intelligent platform providing a chat interface enabling users to enter queries for specific information pertaining to items of a particular industry (e.g., automobile, pharmaceutical, etc.). In an interactive flow, users query any aspect of a desired product to be sold/purchased such as a specific automobile type/make/model and obtain insights into sales concerning product generally. A processing engine interprets the natural language query to obtain the data and present a dashboard for customer viewing of brand-specific content that has been collected from dealerships and/or mined from industry websites. Artificial Intelligence (AI) models are employed to dynamically customize responses to users based on user(s) behaviors, past queries, past and current market factors affecting prices/sales performance, etc. Based on the querying, users are provided with views of brand specific data content, price quotes, recommendations, insights and an actionable plan to improve their own sales and/or increase market share.

### RELATED APPLICATIONS

This application claims the benefit of priority of U.S. provisional applications 63/761,431 filed on Feb. 21, 2025 and 63/809,698 filed on May 21, 2025, the entire contents and disclosure of each of which is incorporated by reference as if fully set forth herein.

### FIELD

The present invention relates generally to machine learning/deep learning models, and particularly methods and systems including a processing platform for facilitating marketplace interactions amongst parties including orchestrating multi-model AI services that generate data analyses and media assets from natural-language inputs, with domain-specific routing, code generation, and asset delivery.

### BACKGROUND

In the context of automobile marketing and sales, traditional automotive marketplaces rely on manual searches and dealership-controlled lead generation. Consumers must navigate complex listings, while dealerships struggle with fragmented marketing tools. Current ecosystems lack integrated AI-driven personalization, real-time inventory management, dynamic content scalability, and autonomous marketing solutions all in one place.

In the context of pharma, pharmaceutical marketing teams face significant challenges in content creation, primarily due to strict regulatory requirements and lengthy medical, legal, and regulatory (MLR) review cycles, which slow time to market. Additionally, marketers struggle to deliver personalized, localized, and compliant messaging across multiple audiences (HCPs, patients, payers, markets) and channels (emails, websites, social media, sales decks).

The demand for high-volume content often necessitates heavy reliance on creative agencies, but this model is cost-prohibitive and limits scalability.

### SUMMARY

A comprehensive agentic AI platform for generating intelligent insights, content, and automating workflows.

A system and method for orchestrating multi-model AI services that generate data analyses and media assets from natural-language inputs, with domain-specific routing, code generation, and asset delivery.

A system and method for facilitating content creating, communications, and automating workflows, and facilitate the analyzing and presenting of relevant content dynamically for use in proactively encouraging and conducting marketplace transactions amongst the parties.

The system and method leverage artificial intelligence resources to provide an AI-powered agent solution that can address challenges to significantly boost creative productivity, reinforce brand guideline compliance, enable personalization at scale, and accelerate content delivery to market-enhancing efficiency, reducing costs, and driving greater impact.

In an aspect, the system and method converts an end-user request into structured inputs, routes the request to domain-specific workflows, selects and invokes one or more large-language models (LLMs) across providers, generates and executes database code to retrieve business data, assembles dashboards, produces media assets (charts/images), and returns results via a low-latency distribution path.

Further to this aspect, the system and method implements a central orchestrator to handle logging, status tracking, and any follow-up actions.

The system and method provide an AI platform that allows for deep extensions into specific verticals. With these enabled, the AI agent comes with a deep understanding and knowledge base of industry-specific data, business logic, compliance requirements, and marketing strategies tailored to that space.

In an aspect, the AI platform can be further personalized to the business needs with client-specific documents and data.

In an aspect, the AI platform provides a system that is able to act as a highly intelligent and capable assistant providing complex reasoning and insights within the guidelines of the vertical and brand.

In the automobile industry, such a system can include automotive extensions that are powered by massive auto-specific datasets and managed content, e.g., by providing core functionality for both consumers and enterprise dealerships.

In an aspect, for the automobile industry, the AI platform provides consumers with advanced vehicle search and recommendation tools to make a purchasing transaction intuitive and painless. For an automobile dealership, one focus is on enhanced lead generation, inventory management, content creation, and automated marketing functionalities.

Further to this aspect, the AI platform is a multi-agent AI system that connects consumers and dealerships in an efficient, automated ecosystem. One key component includes a Core AI Agent that facilitates analytics, content generation, and workflow automation.

In an aspect, powerful design tools use templates and data to scale any content creation capabilities enabling dynamic design.

In an aspect, a marketing orchestrator element provides multi-channel marketing deployment and management.

In an aspect, vertical specific extensions are provided with AI model training conducted on vertical or client specific data sets, business rules, or tech integrations to client-specific tools/software.

In an aspect, there is provided: a computer system for optimized data retrieval. The system comprises: a processor set; one or more computer-readable storage media; program instructions stored on the one or more computer-readable media to cause the processor set to perform operations comprising: receiving a natural language (NL) query from a chat interface, the NL query requesting information used to facilitate performing a task, the information available from one or more distributed data storage systems available to multiple parties; accessing a software agent used to interpret the NL query; and generating, by the software agent, instruction signals based on the interpreted NL query, the instruction signals used to automatically access information from the one or more data storage systems in performing the task, wherein the generated signals comprise one or more signals distributed to the one or more data storage systems and used to dynamically access data for efficient task performance, and one or more signals used to access at least one machine-learned model (ML-model) trained to generate insights regarding the task to be performed; generating, using the trained ML-Model, one or more insights associated with the task to be performed, the software agent using the generated insights to access the most accurate data from the distributed data storage systems for optimized task performance; and presenting, to the user, via chat interface, the accessed data that optimizes, for the user, the task being performed.

In a further aspect, there is provided a computer system. The computer system comprises: a processor set; one or more computer-readable storage media; program instructions stored on the one or more computer-readable media to cause the processor set to perform operations comprising: receiving, from each of a plurality of multiple distributed sources, a respective listing of an inventory of items; aggregating, by a software agent, each received inventory listings of items from each respective source of the multiple distributed sources; receiving, from a user, a NL query associated with a managing of the items of an inventory for a respective source of the multiple distributed sources; accessing the software agent to interpret the NL query; and running, by the software agent, in response to the NL query, at least one machine-learned model (ML-model) trained to generate insights regarding the inventory of items received from the respective source; generating, using the trained ML-Model, one or more insights associated with the managing of the items of an inventory, the software agent using the insights to generate an actionable plan for managing, by the user, the inventory of items of the respective source of the multiple distributed sources; and presenting, to the user, via the chat interface, the actionable plan, the respective source of the multiple distributed sources using the actionable plan to manage its respective inventory of items.

According to a further aspect, there is provided a method for managing an inventory of items. The method comprises: receiving, at a programmed processor, from each of a plurality of multiple distributed sources, a respective listing of an inventory of items; aggregating, by the programmed processor, each received inventory listings of items from each respective source of the multiple distributed sources; receiving, from a user, a NL query associated with a managing of the items of an inventory for a respective source of the multiple distributed sources; accessing, by the programmed processor, a software agent used to interpret the NL query; and running, by the software agent, in response to the NL query, at least one machine-learned model (ML-model) trained to generate insights regarding the inventory of items received from the respective source; generating, using the trained ML-Model, one or more insights associated with the managing of the items of an inventory, the software agent using the insights to generate an actionable plan for managing, by the user, the inventory of items of the respective source of the multiple distributed sources; and presenting, to the user, via the chat interface, the actionable plan, the respective source of the multiple distributed sources using the actionable plan to manage its respective inventory of items.

In a further aspect, there is provided a computer program product for performing operations. The computer program product includes a storage medium readable by a processing circuit and storing instructions run by the processing circuit for running a method. The method is the same as listed above.

### BRIEF DESCRIPTION OF THE DRAWINGS

The foregoing aspects and other features are explained in the following description, taken in connection with the accompanying drawings, wherein:

FIG. 1 is a block diagram depicting an aspect of the multi-agent AI platform that connects entities, e.g., consumers (such as car buyers) and an interconnected computerized network for sellers/manufacturers, etc., s

FIG. 2 is a more detailed block diagram depicting further aspects of the multi-agent AI platform of FIG. 1 that connects entities, e.g., consumers (such as a user buying a vehicle) and an interconnected computerized network for sellers/manufacturers, according to an embodiment;

FIGS. 3A-3B depict a non-limiting embodiment of a user workflow involving coordinated operations invoked and triggered by Core AI Agent 200 of FIGS. 1 and 2;

FIG. 3C shows operations at a continuous-learning processing layer and a predictive model layer according to an embodiment;

FIGS. 4A-4I depict a flow chart of an embodiment of the methods implemented for processing a received user query in the AI agent-based system;

FIGS. 5A-1-5C-depict a sequence diagram illustrating the system operations for fulfilling both consumer/user-side queries/requests or dealer requests according to an embodiment;

FIG. 6 shows an example, non-limiting design of an initial welcome screen that is surfaced to provide a user with options for a user to enter a detailed query via a customized chat LLM prompt according to an embodiment;

FIG. 7 shows an example, non-limiting scorecard presentation of a display providing a user such as a vehicle dealership with “on-brand” market insights in response to an initial generated report according to an embodiment;

FIG. 8A shows an example, non-limiting presentation of an auto intelligence dashboard display providing a user with specific information for the vehicle dealership;

FIG. 8B shows a scorecard presentation depicting the metrics “inventory on hand” “inventory share” amongst local competitors and the specific adjacent result data surfaced for each metric based on data obtained from that specific dealership's store, e.g., as shown in FIG. 8A;

FIG. 9A depicts a screen view display showing example insights and provision of actionable plans for the dealership to inform allocation, marketing decisions, and areas of opportunity to compete with nearby dealerships according to embodiments herein;

FIG. 9B depicts surfacing of a prompt entry input to enable a user to ask the Core AI agent of the system any questions including the downloading of any files or the input of any inquiry in an embodiment;

FIG. 9C shows a further displayed example screen view depicting example results that the Core AI agent has automatically generated in the form of summaries based on a current competitive status for the particular car dealership entity based on data from the on-brand IQ report shown in FIG. 9A;

FIG. 9D shows a further displayed example screen view depicting example results that the Core AI agent has automatically generated in the form of summaries 945 based on the current market trends that can be leveraged for the particular car dealership entity based on data from the on-brand IQ report shown in FIG. 9A;

FIG. 9E shows a further displayed example screen view depicting example results that the Core AI agent has automatically generated in the form of 90-Day marketing and inventory strategies based on the current market trends that can be leveraged for the particular car dealership entity based on data from the on-brand IQ report shown in FIG. 9A;

FIG. 9F shows a further displayed screen view depicting example results that the Core AI agent has automatically generated in the form of successful key performance indicators (KPIs) that is recommended to be tracked periodically for the particular car dealership entity based on data from the on-brand IQ report shown in FIG. 9A;

FIG. 9G shows a further displayed screen view depicting example results that the Core AI agent has automatically generated in the form of a “Quick Win” checklist strategies based on the current market trends and KPIs that can be leveraged for the particular car dealership entity;

FIG. 10A shows a chart of example data used for training the DTS machine-learned model used to predict a duration a vehicle item will be purchased based on one or more of: a state of the current market for the vehicle, a pricing of the vehicle, and a historical trend in an embodiment;

FIG. 10B depicts a plot showing a distribution of the “truth” DOM for different time periods, i.e., quarterly, and particularly a density (Y-Axis) plotted against the DOM (X-axis) for a vehicle(s) in the example implementation depicted in FIG. 10A;

FIG. 11 depicts the adding of additional location data for vehicle identifiers (specific VINs) in an example embodiment;

FIG. 12 depicts a two-tower DTS prediction model architecture in an example embodiment;

FIGS. 13A-13D depict the various dealer level features that can be input to train the DTS model including the procuring of a ground truth days on market (DOM) value used for generating a dealer-level model for global prediction;

FIG. 14 depicts a flow methodology for model development according to an embodiment; and

FIG. 15 depicts a cloud computing environment according to an embodiment of the present invention.

### DETAILED DESCRIPTION

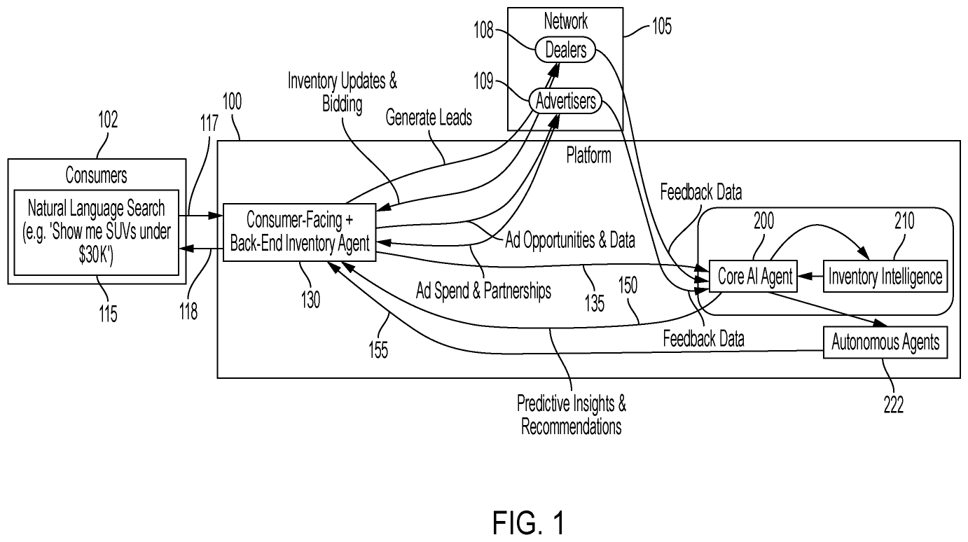

FIG. 1 is a block diagram depicting an aspect of the multi-agent AI platform 100 that connects entities, e.g., consumers 102 (such as car buyers) and an interconnected computerized network 105 for sellers/manufacturers, etc., such as car dealerships 108, advertisers 109, and the like, in an efficient, automated ecosystem.

The intelligent platform consists of a Core AI Agent 200 running systems implementing methods, routines and algorithms to facilitate analytics, content generation, and workflow automation. The Core AI agent 200 interfaces with the network components (e.g., dealers, advertisers, etc.) and consumers 102 to receive requests including request to receive products pricing, inventory requests, customized shopping requests, etc., pertaining to the relevant industry, e.g., car sales, pharmaceutical sales, all via a natural language search interface 115 that can interpret user commands/queries using a natural language processing (NLP) system. Such a NLP system can receive and interpret/process users' inquiries for products, e.g., in the form of natural language queries such as “Show me SUVs under $30K”. The AI platform 100 includes a consumer-facing and back-end inventory agent processing block 130 that can receive any data, tokens or messages representing the received user query 117 as provided by NLP processing content and conduct operations to provide a meaningful result message 118 back to the consumer that provided the initial user query.

As shown in FIG. 1, based on the processing at the consumer-facing back-end inventory agent processing block 130, additional information is searched and provided for potential processing based on the initial received user query 117. For example, in a non-limiting embodiment, consumer-facing back-end inventory agent processing block 130 can provide information back to the networked dealers 108 for the purpose of generating potential sales leads, can receive information from dealers including, but not limited to: inventory updates and bidding prices from competitors or other consumers. Consumer-facing back-end inventory agent processing block 130 can also responsively query advertisers 109 to obtain any potential advertisement opportunities and data and receive potentials advertisement spending offers and partnerships. Some or all of this information received at the consumer-facing back-end inventory agent processing block 130 is forwarded at 135 to the core AI agent block 200. Additionally received at the core AI agent block is feedback data from the dealers 108 and advertiser 109 entities that the Core AI agent 200 use to enhance the intelligence and provide more optimized AI-based search query results 150 such as predicting insights and recommendations that are relevant to the consumer/user's initial natural language query 117.

The core AI Agent 200 in particular receives the information 135 forwarded from the consumer-facing back-end inventory agent processing block 130 and conducts operations to obtain and optimize an answer to the query. The core AI Agent 200 interfaces with various other entities including an inventory intelligence database system 210 that provides current inventory data and relevant product/pricing information to satisfy user requests. The Core AI agent 200 further interfaces with various autonomous agents that perform other tasks relating to analytics, content generation and workflow automation tasks that returns other relevant information 155 in addition to the AI-based search query results 150.

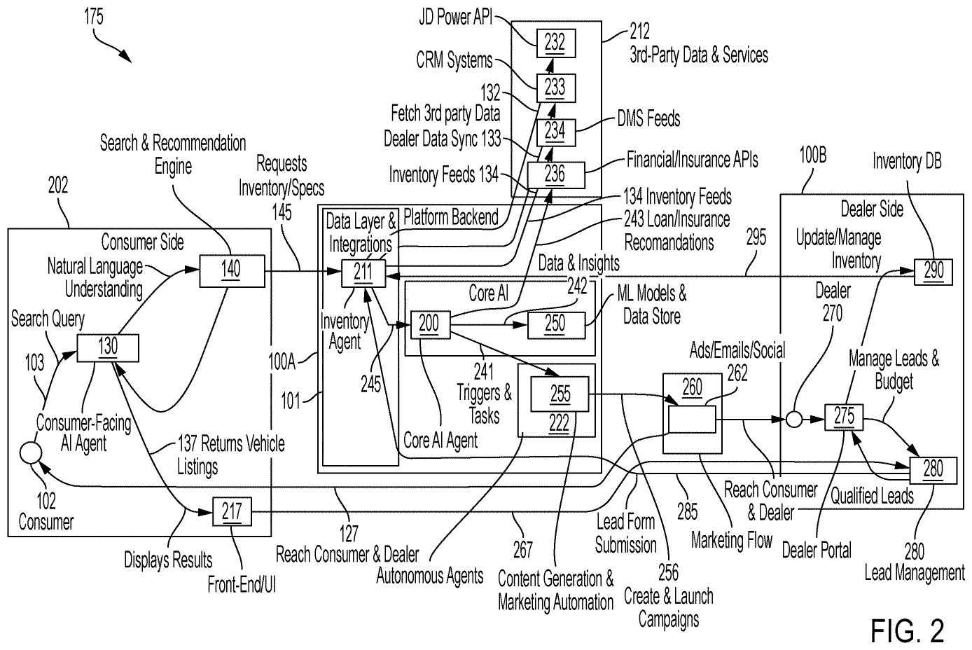

FIG. 2 is a more detailed block diagram 175 depicting further aspects of the multi-agent AI platform 100 of FIG. 1 that connects entities, e.g., consumers 102 (such as a user buying a vehicle) and an interconnected computerized network 105 for sellers/manufacturers, etc., e.g., a car dealership 108, advertiser 109, and the like, in an efficient, automated ecosystem.

As shown in FIG. 2, the intelligent platform 100 of FIG. 1 includes a consumer-facing front-end processing system 202 that enables a consumer 102 to enter (speak or text) a natural language search query 103. This search query is communicated to consumer-facing back-end inventory agent processing block 130 that performs NLP processing to generate a natural language understanding of the query that is represented in a data form and input to a search and recommendation processing engine 140. The platform's search and recommendation processing engine 140 formats the natural language understanding of the user's NL query, e.g., the specific request including inventory request and product specification requests, and inputs this request inventory and/or product specification query data 145 that is received at a backend portion 100A of the platform for processing at a data and integrations processing layer 101. Particularly, at data and integrations processing layer 101, an inventory agent module 211 provides the interfaces for processing the user's query request as it pertains to obtaining inventory intelligence 210 and that includes interfacing with entities of a 3^{rd} party data and services processing block 212.

In particular, 3^{rd} party data and services processing block 212 includes sub-processing modules that include a JD Power and Associates API, financial/insurance services API(s), a customer relationship management (CRM) system application for managing and tracking customer interactions and relationships, tracking leads and customer accounts, and a distributed management system (DMS) feed that manages the distribution of goods and services including handling of tasks such as inventory control, order processing and route management. For example, the platform's inventory agent 211 can respond to received user query requests data 145 by generating: a data request for a 3^{rd} party, where such 3^{rd} party data request message 132 can be handled by the JD Power and Associates API 232; a data request for dealership information, e.g., a dealer data sync request message 133 that can be received/processed by the CRM system 233; and an inventory feed request message 134 for requesting current inventory information from a 3^{rd} party entity that can be received/handled by the DMS feeds application 234. As an example, part of the core AI agent's workflow automation system tasks is to automate repetitive dealership tasks, such as pricing updates and sales reports and to further enhance efficiency by integrating with CRM and marketing platforms.

Such received user query requests data 145 including any 3^{rd} party data request message dealership information, and inventory feed request message for current inventory information can be further input as input messages 245 received at the Core AI agent 200. Based on this received information 245, the Core AI Agent 200 responsively runs methods, routines and algorithms to facilitate analytics, content generation, and workflow automation associated with the received query.

In an example implementation, the Core AI agent 200 component is foundational to the system and functions across verticals. One of the functions includes AI-based data and market analysis where, based on the received information 245, the Core AI agent 200 invokes components that analyze consumer demand, dealership inventory, and competitor data and provides insights for optimal pricing, promotions, and vehicle recommendations. For example, in a non-limiting example implementation, Core AI agent 200 runs such methods, routines and algorithms to initiate and trigger tasks 241 by one or more autonomous agents 222, generate data and insights 242 for input to and processing by one or more machine learned models and data stores 250; and generates load and insurance recommendations 243 particularly for receipt at and processing by the financial/insurance services API(s) 236 that interface with other 3^{rd} party applications.

With more particularity, as shown in the diagram 175 of FIG. 2, with respect to the core AI agent's initiation and/or triggering of specified autonomous agent tasks, one autonomous agent 222 includes a content generation and marketing automation agent 255 which agent include a content generation engine to perform tasks to auto-generate car descriptions, marketing materials, and customer engagement copy. Uses AI models for dynamic ad creation and automated marketing deployment. For example, content generation and marketing automation agent 255 can initiate 256 creating and launching of a particular advertisement/marketing campaign, e.g., by generating a marketing flow 260 that includes electronic advertisements communicated via e-mails and other social media 262 modality. In an example implementation, a marketing flow can include participation of a vehicle dealership, embodied as a dealer entity 270, FIG. 2, which dealer side processing platform 100B can perform various tasks. For example, dealer side processing platform 100B can establish a dealer portal 275 which can interface with a lead management tool 280 that can provide a dealer with qualified leads that may potentially lead to a sale or transaction, and which can manage leads and budgets that can also be accessed through the dealer portal 275. Dealer portal 275 can further interface with an inventory database (DB) 290 that includes the most updated inventory listing and via which manages inventory via dealer portal 275. The dealer network portal 275 is further adapted to provide data analytics on consumer engagement and lead conversion performance. As further shown in FIG. 2, at data and integration layer 101, the inventor agent 211 can obtain and/or directly access and manage submitted leads 285 which indicate potential qualified sales/transaction leads for handling by sales/marketing entities without accessing the dealer portal 275. Further, at data and integration layer 101, the inventor agent 211 can obtain and/or directly access and manage updated inventory listing data 295 directly from the inventory DB 290 without accessing the dealer portal 275.

With more particularity, the Core AI agent 200 can function as an automotive dealer-facing AI agent interfacing with inventory intelligence inventory management system that can aggregate inventory listings from multiple sources (OEM feeds 232, dealer CRMs 233, DMS 234); and further that can normalize real-time data (pricing, availability, offers/promotions). The dealer network portal 275 further enables dealerships to update inventory, manage marketing budgets, and track leads.

As further shown at the consumer side 202 of the AI processing platform, the consumer-facing AI agent interfaces with a front-end user interface (UI) 217 module that can be configured to display, for the consumer, any received results, e.g., any found vehicle listings 137 resulting from the user's initial search. The consumer, via the consumer-facing AI agent 130 can generate/populate a lead submission form via the front end/UI 217 and submit the lead form submission 267 to the lead management tool 280. FIG. 2 also depicts the consumer 102 further receiving reach and dealer data 127 directly via e-mail or social media communication 262 from the marketing flow module 260.

Thus, in an example workflow, the Natural Language Search Engine of the consumer-facing AI agent 130 will accepts a user query input such as “Find a blue electric SUV under $40 k near me.” The Core AI agent 200:1) uses artificial intelligence components to refine results based on budget, location, brand preferences, and historical interactions; 2) provides personalized recommendations by learning from user behavior, saved searches, and viewed vehicles; and cross-references third-party data (e.g., JD Power ratings, consumer reviews) to suggest optimal options; and 3) provides lead generation and engagement by allowing consumers to request quotes or test drives, and enable dealers to bid for high-quality leads, thereby optimizing conversions.

The system platform 100 depicted in FIGS. 1 and 2 specifically provides for a scalable design system providing AI powered insights visualized with an AI powered content built for seamlessly generating rich content at massive scale. The system platform 100 depicted in FIGS. 1 and 2 further provides for agentic marketing orchestration: 1) by integrating with content creation and management tools, the Core AI Agent 200 can, based on queries or interactions with the user, surface relevant marketing assets/content to the user that correspond with the inventory or offers they are searching for; and 2) by integrating with deployment and media management tools, the Core AI Agent 200 can then deploy the marketing content into third party channels (such as Meta, Google, email, etc.) on the user's behalf. The Core AI Agent 200 can also pull in performance data to assess how the campaigns are performing, further informing its next recommendation regarding content, channel or targeting recommendations for the user. With respect to these foundational components in platform 100 of FIGS. 1 and 2, they are configured to function across verticals, i.e., there are vertical specific extensions built into these components to cater to specific use cases within the automotive vertical.

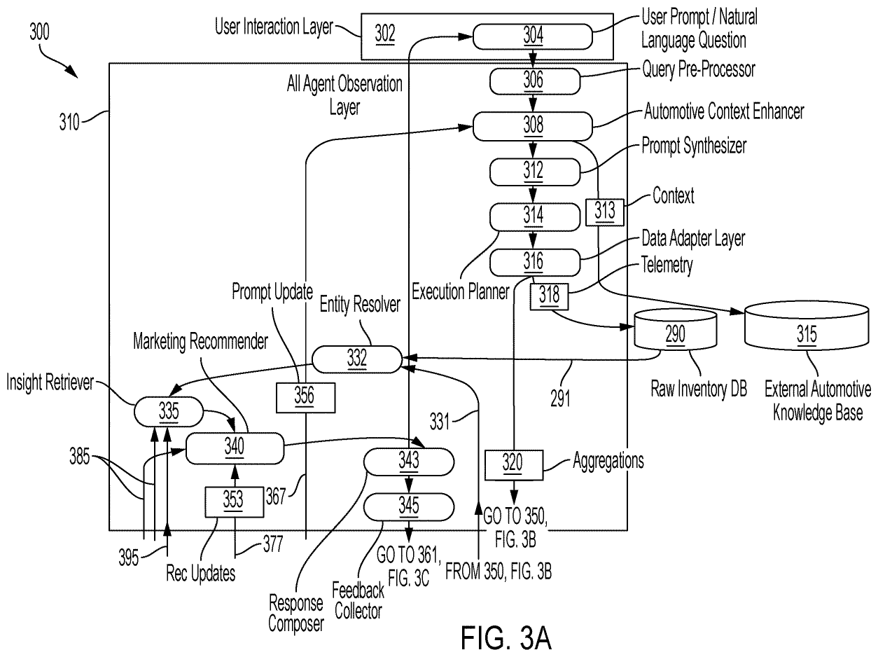

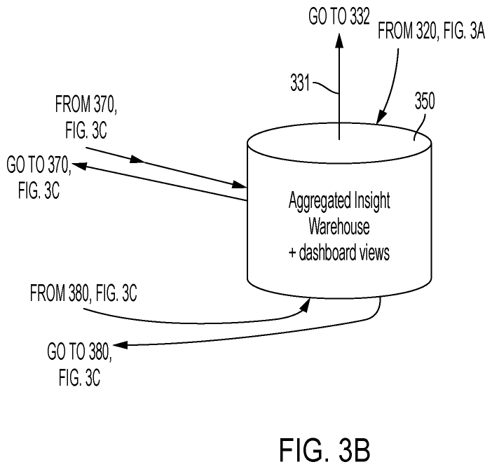

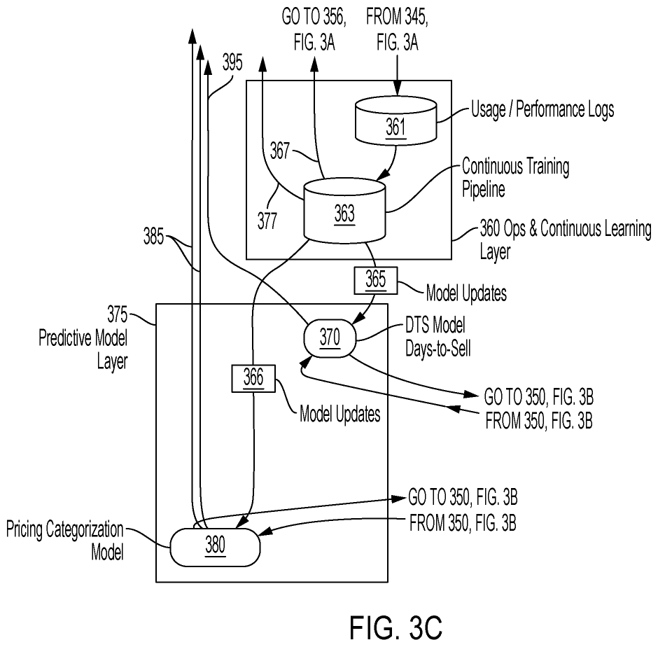

FIGS. 3A-3B depict a non-limiting embodiment of a user workflow 300 involving coordinated operations invoked and triggered by Core AI Agent 200 of FIGS. 1 and 2. Via user interaction layer 302, a menu driven interface can be displayed on a user device that prompts the user to enter a natural language question 304. Any user-entered query is received at the AI Agent Orchestration layer 310 of the Core AI Agent, where the query is subject to one or more of: pre-processing/filtering operations as performed by query pre-processor 306, and subject to any context enhancing as performed by automative context enhancing element 308. Based on a determination of the need for automative context enhancing, from 308, FIG. 3A, the process can proceed to either a series of steps to prompt further processing by a prompt synthesizer 312, trigger and execution planner 314 and forward this information to a data adapter layer component 316. From data adapter layer component 316, the processed NLP query can be forwarded by either a telemetry component 318 for storage in the raw inventory DB 290 and/or forwarded to an aggregator component 320 configured to forward the processed NLP query to a storage database, such as an aggregated insight warehouse data store 350, FIG. 3B that can format stored data to provide a user with dashboard views. Otherwise, from 308, FIG. 3A, the process can be forwarded to context component 313 for further storage in an external automative knowledgebase DB 315. The data stored in raw inventory DB 290 and external automotive knowledgebase 315 can be data from such sources including but not limited to: inventory, incentives, audience, web analytics, ad analytics, sales/registration, 1st party integration (client data) and other marketplace data.

As further shown in FIG. 3A, the system forwards any raw inventory data 291 stored in inventory DB 290 as well as any aggregated data 331 from aggregated insight warehouse DB 350 to an entity resolver component 332 which can forward these received data to an insight receiver component 335. The insight receiver component 335 of FIG. 3A can forward the data and/or requests to a marketing recommender component 340 which formats the request for further processing by a response composer element 343 and a feedback collector component 345. Feedback collector component 345 forwards the enhanced query content to a query/performance logs database 361 of an operations and continuous-learning processing layer 360, FIG. 3C. This data can be further stored in a continuous training pipeline DB 363, FIG. 3C, e.g., for use in continuously training the predictive DTS model at predictive model layer 375, FIG. 3C.

With respect to the predictive model layer 375, FIG. 3C, in on-line or off-line processes, any stored enhanced query content stored in a query/performance logs database 361 and continuous training pipeline 363 can be filtered to obtain updated model training data at model update component 365. These model updates 365 can be forwarded to the Days-to-Sell (DTS) predictive model 370 run at predictive model layer 375. The DTS predictive model 370 can forward data to and receive further training data from aggregated insight warehouse database 350 in FIG. 3B. As further shown, predictive model layer 375 further invokes training and use of a pricing categorization model 380 by providing a bi-directional interface with aggregated insight warehouse database 350 in FIG. 3B. The pricing categorization model 380 can obtain further information and data from the continuous training pipeline DB 363, FIG. 3C for training the pricing categorization model 380. This data from continuous training pipeline DB 363 is formatted as model update data 366 for input/use by pricing categorization model 380. As further depicted in FIG. 3B, 3C, model invocation results data 385 obtained from running the pricing categorization model 380 and model invocation results data 395 obtained from running the DTS model 370 are both forwarded to Core AI agent orchestration layer 310. For example, DTS model 370 results data 395 is forwarded to insight retriever block 335, which can be additionally forwarded for input to the marketing recommender processing block 340. Similarly, pricing categorization model 380 results data 385 obtained from running the pricing categorization model 380 are data forwarded as a direct input to the marketing recommender processing block 340 and as additional input to insight retriever block 335.

As further shown in FIG. 3C, model training data 367 from the continuous training pipeline DB 363, FIG. 3C, can be further formatted as prompt updates data 356 for input to additional content enhancer component 308, FIG. 3A. Further, model training data 377 from the continuous training pipeline DB 363, FIG. 3C, can be further formatted as recorded updates data 353 for input to marketing recommender component 340, FIG. 3A.

In an embodiment, the processing blocks depicted in FIGS. 3A-3C can be configured to enable consumer interactions. An exemplary consumer interaction flow can entail steps performed by the system that include: 1) receiving a user inputs a natural language search query; 2) processing by the Core AI Agent 200 of any user preferences, database searching, obtaining results, refining results, and recommending vehicles. For example, the consumer can select a vehicle and submits a lead request. Any dealership/dealer entities with a matching inventory can bid for the lead and the consumer can then receive a dealer quote(s) and test drive option(s).

In an embodiment, from the dealer perspective, the processing blocks depicted in FIGS. 3A-3C can be configured to enable dealer engagement interactions. An exemplary dealer interaction flow can entail steps performed by the system that include: 1) registering a dealer on the platform and the dealer uploading its inventory; 2) using AI to synchronize and normalize listings; 3) setting, by the dealer, marketing budgets and bidding preferences; 4) using AI to match leads to dealers based on vehicle inventory and consumer demand; and 5) receiving, at the dealer, analytics on lead performance and marketing return on investment (ROI).

As part of this processing, there is additionally created an AI-driven campaign that entails 1) using AI to analyze a dealer's inventory and marketing data; 2) using AI to generate campaign assets (ad copy, visuals, targeting parameters); 3) deploying the campaign and monitoring the campaign in real time; and 4) using AI to adjust marketing parameters dynamically based on performance. The system of FIGS. 3A-3C provides an AI-driven marketing automation tool that generates campaign materials (ads, emails, social media posts) automatically and uses predictive analytics to optimize pricing, promotions, and target audiences.

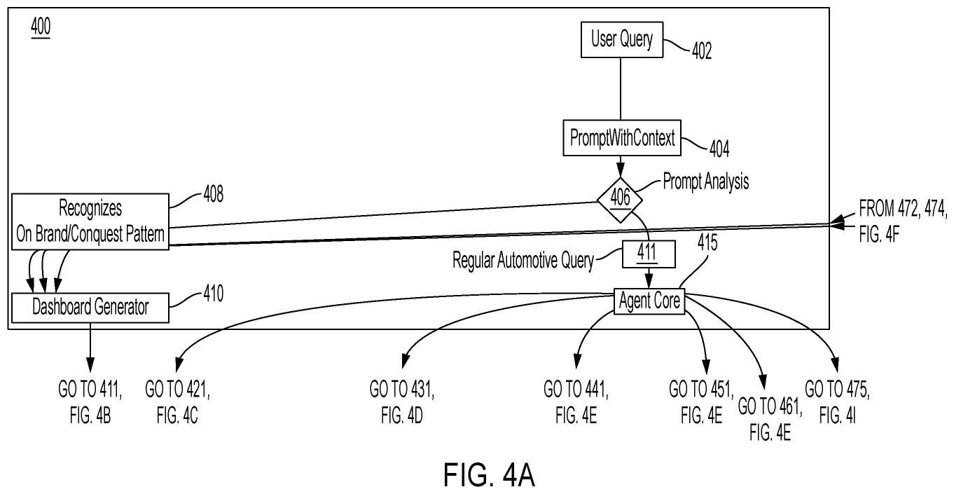

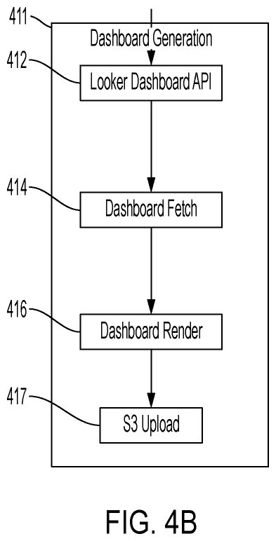

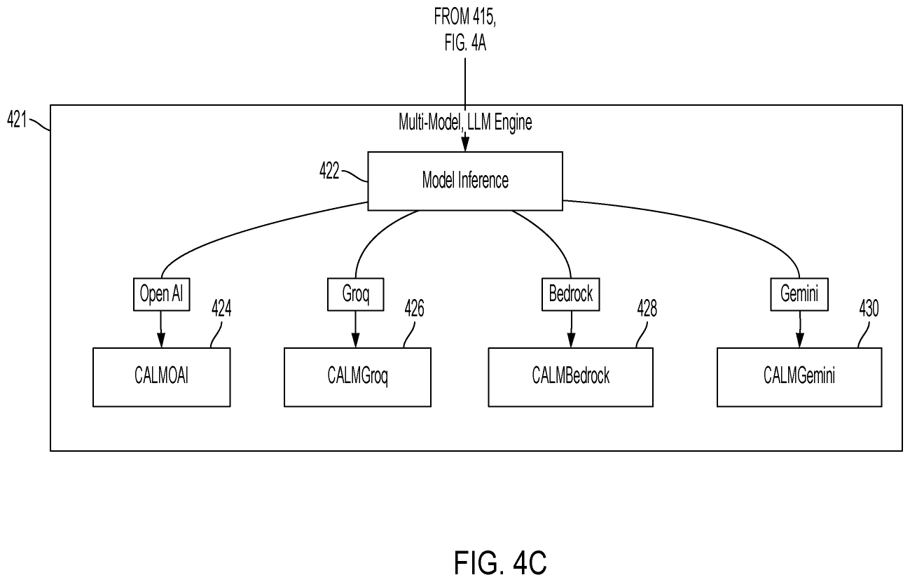

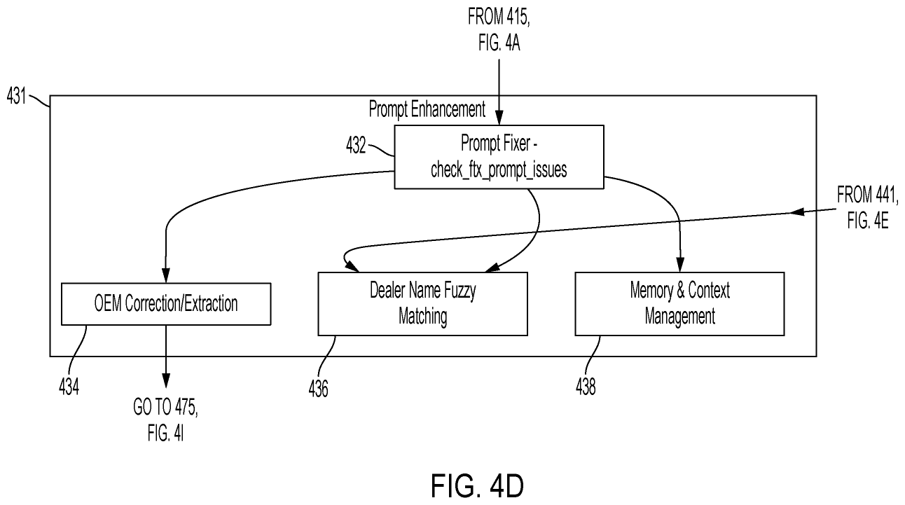

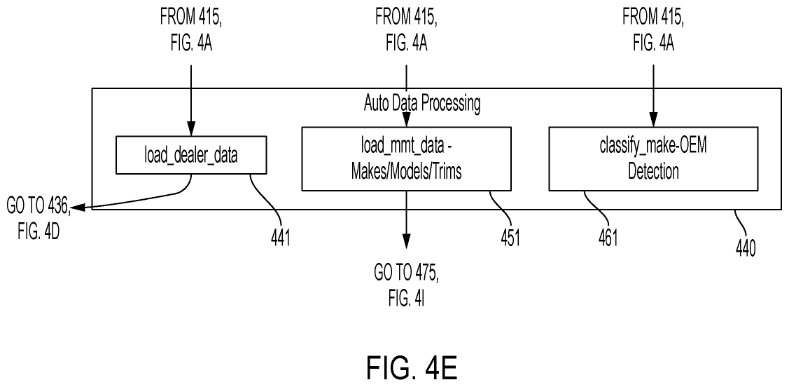

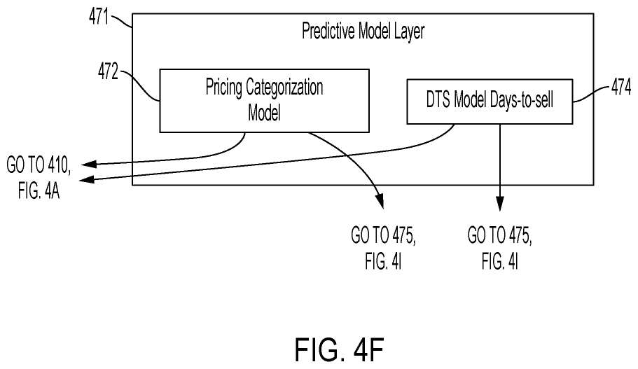

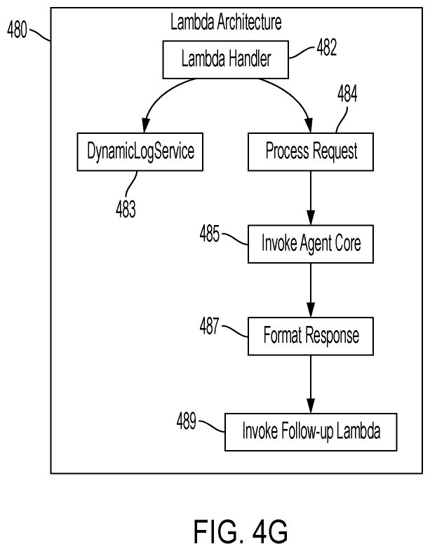

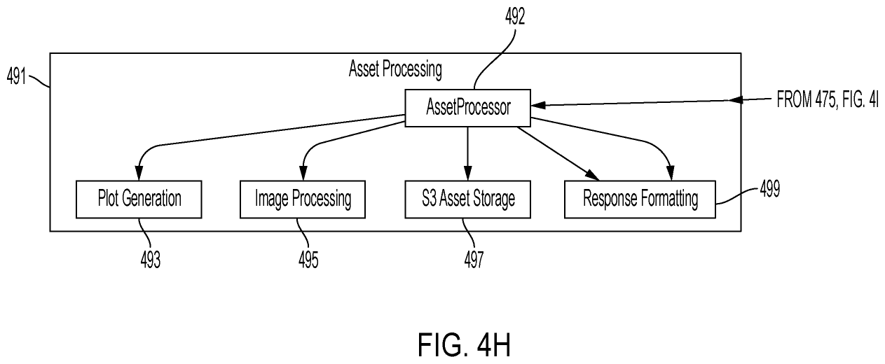

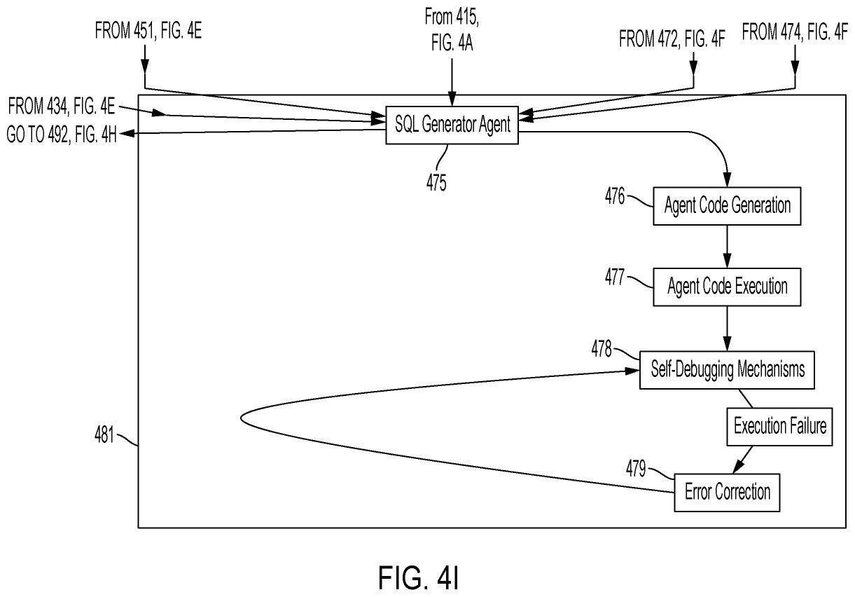

FIGS. 4A-4I is a flow chart depicting an embodiment of the methods implemented for processing a received user query in the AI agent-based system. FIG. 4A depicts an initial flow diagram of the user processing 400 conducted. As shown in FIG. 4A, the natural language processor receives a user query at 402 and at 404, generates a PromptwithContext command and, at 406, determines whether prompt analytics is requested based on the user/query context. In one implementation, based on analytics request at 406, the process proceeds to 408 where the system recognizes on-brand/conquest pattern—i.e., the system has received this or a related query/inquiry before. As such, the process invokes a dashboard generator API 410 to extract data for forming a dashboard presentation for that user and the process proceeds to a dashboard generation process 411 depicted in FIG. 4B. Otherwise, returning to 406, at 411 it is determined that the analytics request type at 406 is directed to a regular automotive query, the process proceeds to 412 to invoke the Core AI agent processing at 415. From FIG. 4A, at 415, depending upon the prompt type the process proceeds to invoke one or more of: a multi-modal LLM engine of 421, FIG. 4C; a prompt enhancement engine 431, FIG. 4D; an autodata processing engine 440, FIG. 4E; a lambda architecture processing 480, FIG. 4G; an SQL generation and extraction engine 481, FIG. 4I. FIG. 4F shows a predictive model layer 471 for carrying out some of the functionality of predictive model. FIG. 4H shows an asset processing layer 491 invoked by the SQL generation agent 475.

FIG. 4B shows the dashboard generation process 411 of the AI agent-based system including process steps of loading of the dashboard API at 412, fetching the dashboard at 414 and invoking the dashboard render at 416 in which case the user's customized dashboard is surfaced for user display. At 417, FIG. 4B, the dashboard is uploaded to the user's display device. The dashboard generator calls analytics service APIs to fetch dashboards; and caches responses in object storage for reuse.

FIG. 4C shows the invocation by the Core AI agent of the AI agent-based system at 415, FIG. 4A, of the multi-modal LLM engine process 421 including invoking model inference block 422, e.g., a chat interface for user to enter query via the displayed model prompt. In an embodiment, the multi-model LLM engine is the “AI brain trust” consisting of a pool of different AI models accessible for different tasks and providing a unified interface over: OpenAI (GPT-4/O3) providing primary reasoning, SQL generation; Groq, providing fast inference when speed is critical; AWS Bedrock, providing large document analysis; and Gemini, providing prompt correction, OEM detection, etc.; and provides for the switching of models per task or fallback. In effect, multi-modal LLM engine process 421 optimizes cost/quality/latency; provides resiliency against provider outages or drifts. In an embodiment, a user is enabled to use an entry prompt associated with any large language model and provides call interfaces to invoke any chat LLM engine by calls such as: CalMOAI OpenAI model 424, a CalMGroq model 426, a CalMBedrock model 42 and a CalMGemini model 430, FIG. 4C. Different AI models excel at different tasks. Using the right model for each job improves accuracy and reduces costs.

FIG. 4D shows the invocation by the Core AI agent of the AI agent-based system at 415, FIG. 4A, of the prompt enhancement process 431 including invoking prompt fixer block 432, e.g., to check for any prompt issues as entered by a consumer/user. In an embodiment, should there be determined presence of any issues related to the prompt, the process will invoke one or more of: a process for OEM correction/extraction processing block 434; a fuzzy matching process 436 for fuzzy matching an entity, e.g., a dealer name; and, a memory and context management block at 438 to invoke any type of data storage based, e.g., on user context determinations. In an embodiment, the prompt enhancement process 431 is the “editor” that fixes and improves user questions before processing particularly by: 1) OEM Correction: fixing brand names (e.g., “bimmer”-> “BMW”, “JLR”-> “Jaguar Land Rover”); 2) Dealer Name Fuzzy Matching: correcting typos in dealer names using smart matching; and 3) Memory Management: adding context from earlier messages in the same conversation. Thus, as users do not always spell things perfectly or provide complete context, this layer ensures the AI understands what they actually meant.

FIG. 4E shows the invocation by the Core AI agent of the AI agent-based system at 415, FIG. 4A, of the autodata processing blocks including the invoking of a load_dealer_data processing block 441, FIG. 4E. e.g., to fetch, load and return dealer data; a load_mmt_data processing block 451 to fetch, load and return and load management data such as automobile makes/models and corresponding trims; and a classify make-OEM detection process 461. The load_dealer_data processing block 441, can send a further request to perform a dealer name fuzzy matching by invoking dealer name fuzzy matching process 436, FIG. 4D.

FIG. 4F depicts a further predictive model layer process 471 of the AI agent-based system including the invoking of a price categorization model 472 and/or the DTS (Days-to-Sell) model 474 that constitutes the “forecasting engine” that adds intelligence beyond raw data. In particular, the Days-to-Sell (DTS) is the predicted number of days until a vehicle will sell; and Pricing Categorization is a prediction whether a vehicle is priced competitively (well-priced, overpriced, etc.). These processes transform raw inventory data into actionable business insights. Dealers can prioritize vehicles that are slower to sell or adjust pricing, e.g., modeled outside the pipeline. Both of the price categorization model 472 and the DTS model 474 processes of FIG. 4F are shown further invoking the dashboard generator at 410, FIG. 4A. Further, both of the price categorization model 472 and the DTS model 474 processes of FIG. 4F are shown further invoking an SQL Generator Agent 475 in the SQL generation and execution block 481, FIG. 4G.

FIG. 4G depicts a further flow diagram of the lambda handler invoked in the AI agent-based system. In an embodiment, the lambda handler is an orchestration layer providing coordinates modules; writing logs/state to a database; tracking job status; and triggering follow-up workflows to result in a reliable, auditable execution with recoverability and downstream automation. As shown in FIG. 4G, a lambda architecture 480 is shown depicting a lambda handler 482 that feeds one or both of: a dynamic log service application 483 along a first path, and a path to conduct a process request at 484, invoking the Core AI Agent 200 at 485, format the response obtained by the system at 487 and then invoke a follow-up lambda at 489.

FIG. 4H depicts a further flow diagram of the asset processing invoked in the AI agent-based system. As shown in FIG. 4H, an asset processing block 491 is shown depicting an asset processor 492 that invokes other related asset processes including but not limited to: a plot generation process 493, an image processing application 495, a system asset storage 497 and a response formatting processing block 499. Asset processing block 491 provides methods and routines for building charts, images (model APIs), and videos; storing outputs in object storage and serves via content delivery network (CDN). Asset processing block 491 provides a scalable, cacheable media delivery, providing uniform artifact management across formats.

FIG. 4I depicts a further flow diagram of the SQL generation and execution block 481. As shown in FIG. 4I, an SQL generation and execution block 481 request can be received at the SQL generator agent 475 directly from the Core AI agent 415, FIG. 4A; and/or from the price categorization model 472 and the DTS model 474 processes of FIG. 4F; and/or from the load_mmt_data makes/models/trims processing block 451, FIG. 4E; and/or from the OEM correction/extraction processing block 434, FIG. 4D. The SQL generator agent functions as a code/query synthesizer that selects relevant database schemas; generates Python/SQL; executes; auto-debugs based on runtime errors or validation checks.

Invocation of SQL generator agent 475 can trigger further processing of an agent code generation processing block 476, an agent code execution block 477, and self-debugging mechanisms 478 and/or any error correction should there be an execution failure detected. A feedback loop is implemented to ensure upon indication of an execution failure, that the process is corrected and returns to the self-debugging mechanism 478, FIG. 4I. In one instance, SQL generation agent block 475 can invoke asset processor 492 at asset processing block 491 and any of the sub processes thereof of asset processing block. An advantageous effect is to provide end-to-end query automation with closed-loop correction and improving first-pass success.

FIGS. 5A-1-5C depict a sequence diagram illustrating the system operations 500 for fulfilling both consumer/user-side queries/requests or dealer requests. At 501, a user is depicted generating a user query 502 that is received by the system, e.g., via a prompt interface provided to enter a NLP query 502. In the case of the automotive industry, a user at 501 can be any person using the system—typically a dealership employee, OEM analyst, or marketing team member. They can ask example questions/queries in natural language such as: “Show me BMW inventory under $50,000” or “Give me my On-Brand report for last month.”

Receipt of this query invokes an input validation layer in the form of surfacing a PromptWithContext command 504 such that a prompt analysis is requested at prompt analysis processing block 505 in order to determine a query context. In an embodiment, the PromptWithContext is an “intake form” for every user request and causes the system to bundle together everything the system needs to process a user's question, including but not limited to: 1) the user's actual question; 2) their account/dealership information; 3) any brand or dealer filters; 4) a conversation history from previous messages; 5) any uploaded files (PDFs, images). This step ensures every question arrives with full context so the AI can give relevant, personalized answers. In an embodiment, the PromptWithContext command enforces a strict schema for incoming requests (e.g., prompt text, filters, IDs, metadata) having an effect of reducing processing errors and enabling deterministic routing and auditing. For example, prompt analysis includes a semantic routing module that classifies requests to predefined domains (e.g., automotive, creative) using vector embeddings and similarity to training utterances. In effect, semantic routing increases routing precision versus keyword rules; and enables domain-specific policies.

In determining context, the prompt analysis processing block 505 requests invocation of a dashboard generator process 507 that invokes the looker dashboard API, fetches the dashboard for that user, renders the dashboard on the user's display device and uploads the dashboard display to the user device at 509. In an embodiment, prompt analysis processing block 505 is a “traffic controller” that decides how to handle each question by using AI to classify what type of question is being asked: e.g., “Looker” questions that, in response, route to pre-built dashboards (On-Brand/Conquest reports); “Inventory” questions that, in response, route to the live database for custom data queries; and “Greetings/Help” question, that, in response, provide simple responses without database access. These processes ensure questions get answered by the right system-fast dashboard lookups for standard reports, or full data analysis for custom questions.

As part of the dashboard generation, the dashboard generator process 507 can invoke operations at the predictive model layer 471 (FIG. 4F) to receive one or more of the predicted DTS data results 511 from the run DTS predictive model 474, FIG. 4F and/or to receive one or more of the predicted price categorization data results 511 from the run price categorization predictive model 472, FIG. 4F. The dashboard retrieval with cache (“dashboard generator”) calls analytics service APIs to fetch dashboards; caches responses in object storage for reuse. In effect, the dashboard retrieval with cache implemented by dashboard generator cuts latency and external API load; and ensures consistent dashboard versions. In an embodiment, the dashboard generator process 507 is a “report factory” for standard analytics reports by: connecting to “Looker” business intelligence platform; applying dealer-specific filters (e.g., name, website, OEM brand); generating branded PDF/image dashboards; caching reports for instant reuse; uploading finished reports to cloud storage for delivery. In response to certain questions like “Show me my On-Brand report” or “Give me GA4 analytics” the dashboard generator process 507 will generate standard, templated reports.

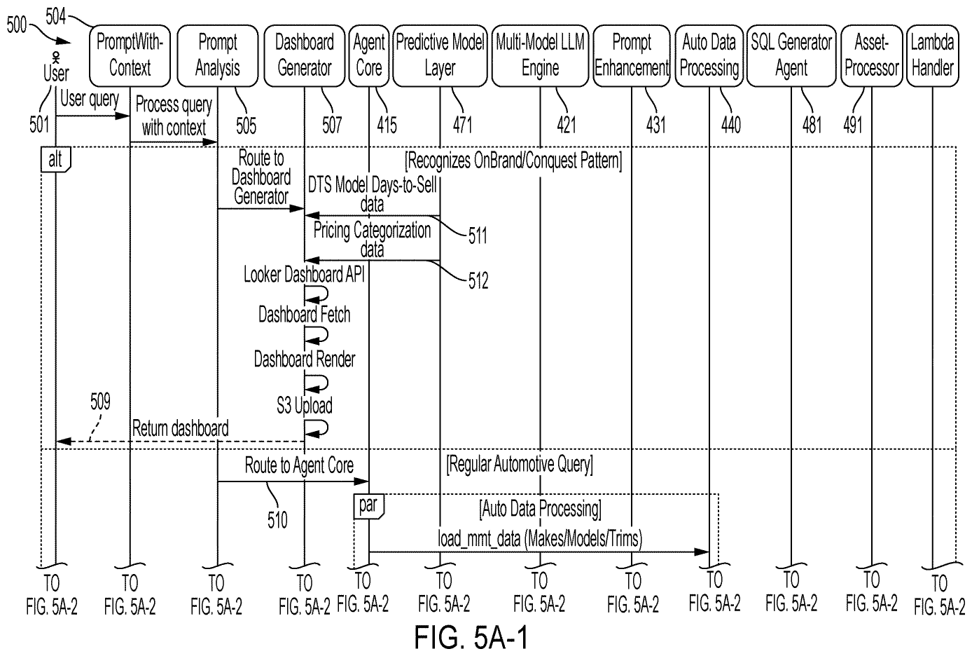

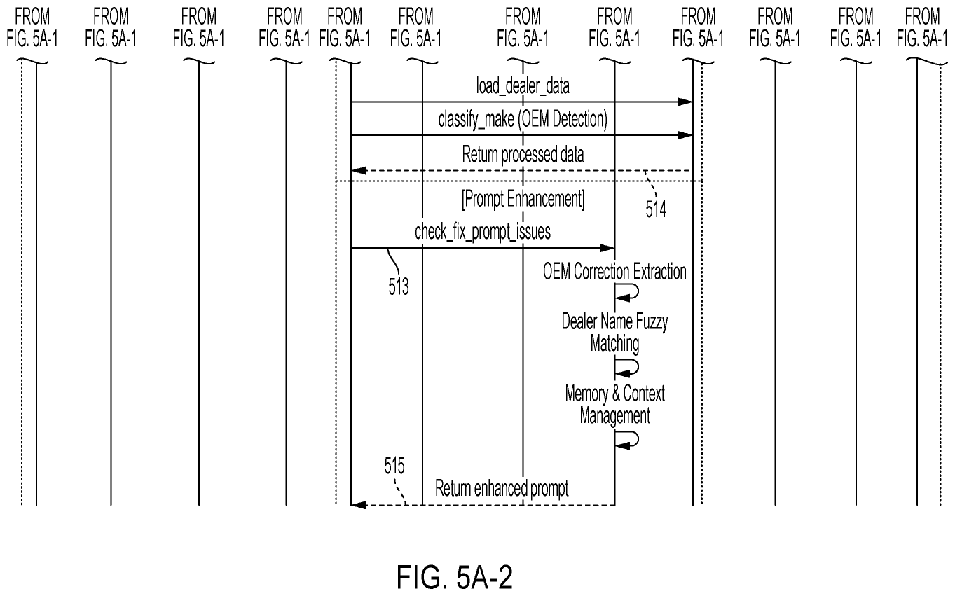

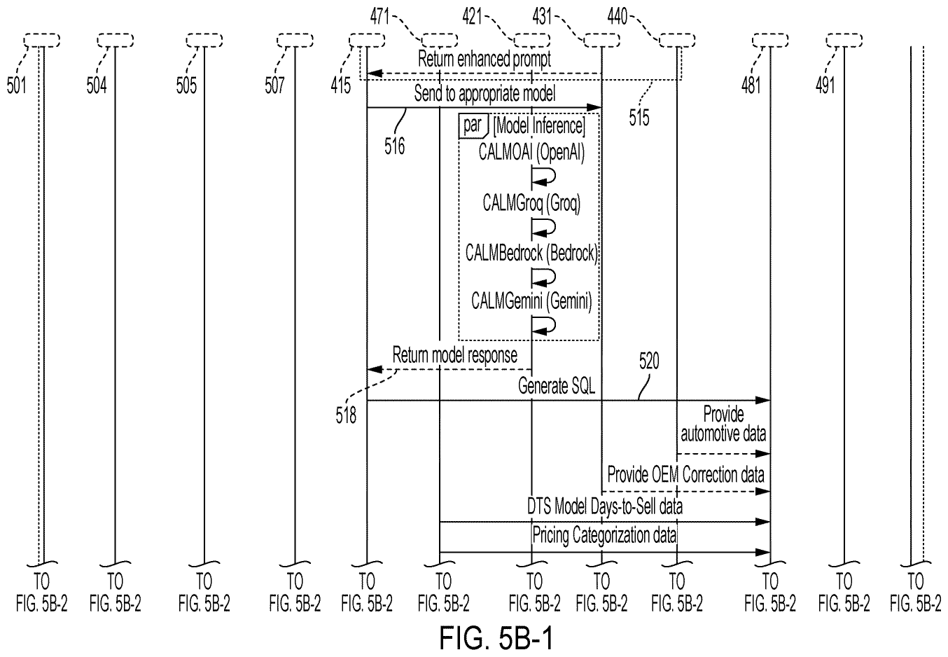

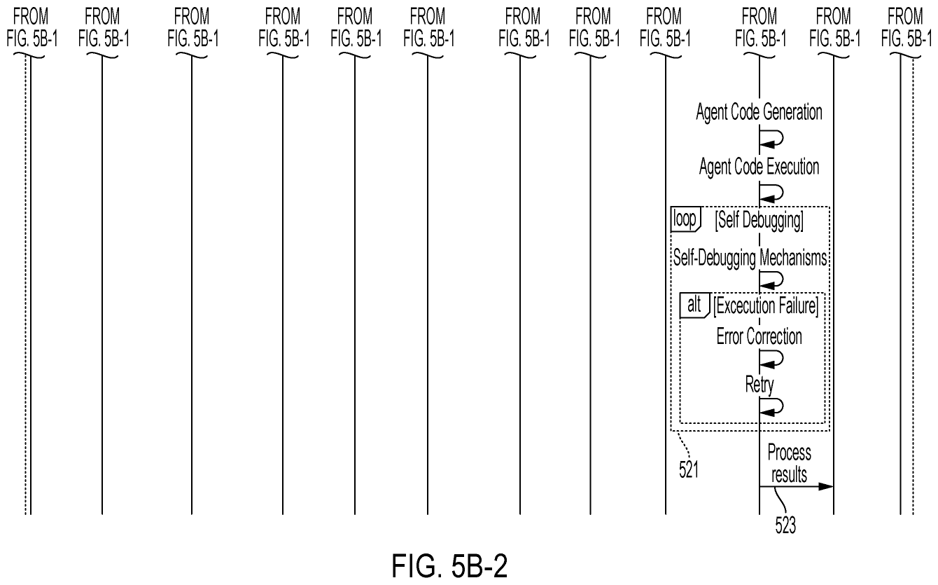

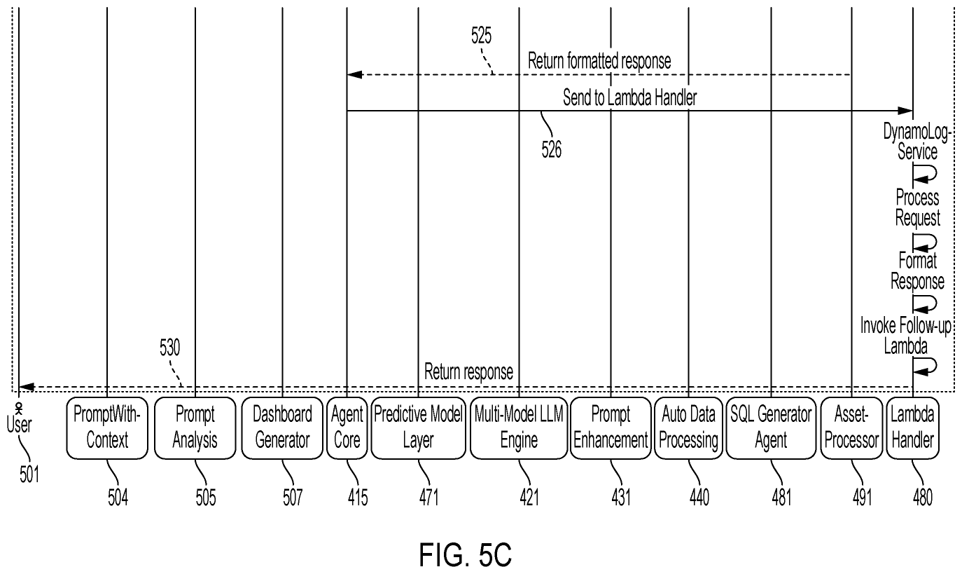

In an additional use case for a received user query, the prompt analysis processing block 505, FIG. 5A-1 can trigger at 510 an invocation of the Core AI agent processing block 415 (See FIG. 4A) for regular automotive queries. In an embodiment, the Core AI agent processing block 415 is the “brain” and central orchestrator of the entire system by: receiving the packaged user request; initializing all the specialized AI models needed; coordinating parallel workflows (data processing+prompt enhancement); managing the conversation flow from question to answer; handling file uploads (PDFs, images) and returning the final formatted response. The Core AI agent processing block 415 is the command center that ensures all the pieces work together seamlessly.

In an embodiment, e.g., based on user context, the Core AI agent processing block 415 can run auto data processing steps at Auto Data processing layer 440, FIG. 4E in order to determine one or more of: any particular automobile makes, models, trims, the relevant dealership data the relevant make classification (OEM detection) as performed by the auto data processing layer 440. The auto data processing layer 440 functions as the “automotive knowledge base” that searches and provides knowledge about cars and dealerships. In an embodiment, it can provide: MMT Data: e.g., providing a complete database of Makes, Models, and Trims (e.g., all 2024 BMW X5 variants); Dealer Data: e.g., providing information about dealership names and locations; and OEM Classification: e.g., identifying which brand a model belongs to when not specified. Aa automotive questions require domain expertise, this auto data processing layer 440 component provides the car knowledge the AI needs.

The auto data processing layer 440 can retrieve the relevant data at 514 and format it for display via the user's dashboard presented. In a further embodiment, shown in FIG. 5A-1-5A-2, e.g., based on user context, the Core AI agent processing block 415 can run prompt enhancement processing steps at prompt enhancement processing layer 431, FIG. 4D in order to request correction/enhancement of a LLM model prompt entry at 513 to correct/enhance any one or more of: any particular extracted OEM to be determined/corrected, a dealer name determined by employing a dealer name fuzzy matching technique, or to perform any memory or context management as invoked by the prompt enhancement processing layer 431. The prompt enhancement processing layer 431 can retrieve the relevant corrected/prompt-enhanced data and format and return it at 515 for display via the user's device LLM model interface.

As further shown in FIG. 5B-1-5B-2, responsive to receipt of the returned enhanced prompt 515, the Core AI agent processing block 415 can further run at 516 the multi-modal LLM processing block 421 in order to run the corrected/enhanced user query entered into the prompt in the chosen LLM (large language model) such as OpenAI, Groq, Bedrock, Gemini and at 518 return the appropriate model's response.

As further shown in FIG. 5B-1-5B-2, responsive to receipt of appropriate the model response 518, the Core AI agent processing block 415 can further run at 520 the SQL generation and execution agent processing block 481 in order to run the query entered into the prompt in the chosen LLM (large language model) such as OpenAI, Groq, Bedrock, Gemini. Additionally provided for processing at the SQL generation and execution agent is the automotive data provided from the autodata processing block 440, any provided OEM correction data from the prompt enhancement block 431, any predicted DTS data based on the predictive DTS Model, and any price categorization data from the predictive price categorization model run at the predictive model layer 471. The SQL Generator agent block 481 in particular, is the “data retrieval specialist” that turns questions into database queries by: 1) Code Generation: e.g., converting natural language into SQL queries; 2) Code Execution: e.g., running queries against the inventory database (Redshift); 3) Self-Debugging: e.g., if a query fails, the process automatically fixes and retries (e.g., up to 3 attempts); and 4) Quality Validation: e.g., using a “judge” AI to verify the query is correct before running. This functionality enables users to ask complex data questions without knowing SQL and the self-debugging ensures reliable answers even for tricky questions.

Based on the processing at the SQL generation and execution agent processing block 481, there is performed one or more of: generating agent code and executing agent code; entering a self-debugging processing loop 521 that invokes self-debugging mechanisms to detect any execution failures, provide for any error correction and retry the execution. At 523, FIG. 5B-1-5B-2, the process results are forwarded to the asset processing block 491, FIG. 4H, which functions as the “packaging department” that prepares visual outputs for delivery. In particular, asset processing block 491 performs: 1) Chart Generation: e.g., creating bar charts, line graphs, pie charts, etc.; 2) Image Processing: e.g., preparing images for web display; 3) S3 Upload: e.g., storing all visual assets in cloud storage; 4) Response Formatting: e.g., packaging everything into a clean, frontend-ready format; and 5) Captioning: e.g., adding AI-generated descriptions to charts. This functionality turns raw data into beautiful, shareable visualizations and ensures all images/charts are accessible via secure URLs.

After processing the data results at asset processing block 491, the formatted response is returned to the Core AI Agent 415. Then at 526, FIG. 5C, the Core AI Agent 415 then sends the formatted response to the Lambda handler processing block 480, FIG. 4G which invokes any dynamoLog Service, invokes a ProcessRequest, formats the response and invokes a follow-up Lambda. After such operations, the final response 530 is returned back to the user 501. More particularly, Lambda handler processing block 480 is the “shipping dock” that manages the serverless infrastructure particularly by: 1) Request Handling: e.g., receiving incoming API requests from the frontend; 2) Logging: e.g., recording everything to DynamoDB for audit/debugging; 3) Status Tracking: monitoring success/failure of each request; 4) Followup Chaining: e.g., triggering the next Lambda in the pipeline (for notifications, etc.); and Response Delivery: e.g., returning the final answer to the user. This functionality provides a reliable infrastructure layer that ensures requests get processed and responses get delivered—even at scale.

In view of the system architecture of FIGS. 3A-3C and the processing methods of FIGS. 4A-4I and FIG. 5A-1-5C, the auto intelligence agent of the present embodiment combines sophisticated data insights with an AI chat interface built-in for seamless access to insights.

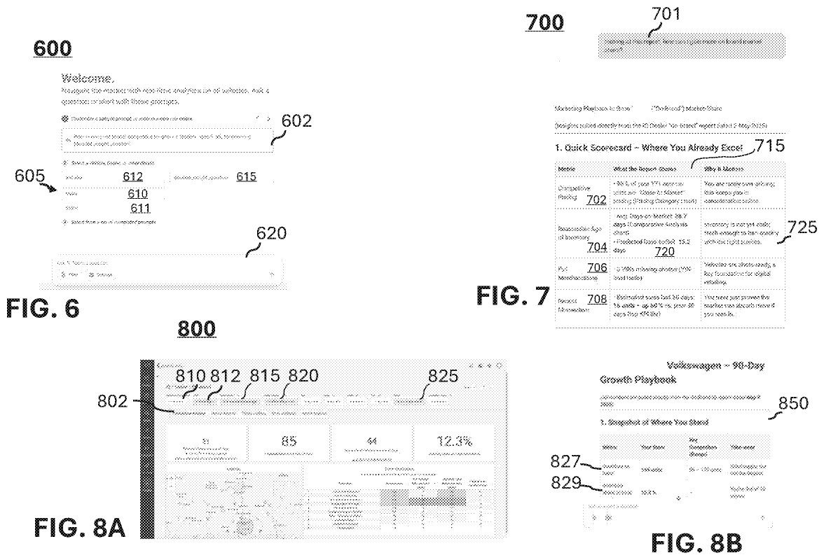

FIG. 6 shows an example, non-limiting design of an initial welcome screen 600 that is surfaced to provide a user with options for a user to enter a detailed query via a customized chat LLM prompt 602. For example, a user can provide a query entry in the form of a “conquest” (a desired vehicle make) 610, any provide “competitive insights” for entry to a dealer 611, or for entry to any particular vehicle website 612, and to provide the prompt entry with a “detailed_insight_question” 615. Via surfacing of another prompt entry input 620, a user is enabled to query the Core AI agent of the system any questions including the request of downloading of any files or the selection of any settings.

FIG. 7 shows an example, non-limiting scorecard presentation 700 of a display providing a user such as a vehicle dealership with “on-brand” market insights in response to an initial generated report. That is, via a chat prompt entry 701 based on the surfaced report, how a dealership can “gain more on-brand market share?” The processes invoked by Core AI agent 415 in FIG. 4A can be invoked and the data learned can populate a quick scorecard presentation 700 of FIG. 7. The scorecard presentation 700 of FIG. 7 provides a column of metric categories such as a “competitive pricing” metric 702, a “reasonable age of inventory” metric 704, a “full merchandising” metric 706 and a “recent momentum” metric 708 and for each, the corresponding details of what the report shows for these metrics for that dealer. For example, for each of the “competitive pricing” metric 702, a “reasonable age of inventory” metric 704, a “full merchandising” metric 706 and a “recent momentum” metric 708 there is provided an adjacent corresponding “what the report shows” entry 715 which is the result of the insights analysis conducted for that dealer issued in another report and also an adjacent corresponding “why it matters” entry 725 with additional important information that can be used to gain market share. For the example “reasonable age of inventory” metric 704, there would be surfaced in this scorecard report details 720 of the “on-brand” report that show the current average “days-on-market” as predicted by the DTS prediction model for that dealership as compared to a DTS Prediction metric, i.e., a predicted days-to-sell 712, as was pulled from the dealer “On-brand” report dated May 2, 2025. For the example “reasonable age of inventory” metric 704, there would also be surfaced in this scorecard report details 725 of why and how the information for that metric for that dealership particularly matters.

FIG. 8A shows an example, non-limiting presentation 800 of an auto intelligence dashboard display providing a user with specific information for the vehicle dealership, including, for example, an indication of the presence of any gaps that block market-share growth. The dealer particularly enters via the IQ: Dealer: On-brand website information such as: the dealership group name 810, the OEM 812, the dealer name 815, the dealer website 820 and a status indication 825, e.g., whether the vehicle is on lot or in transit. For example, by selecting a “competitive analysis” tab 802, for that vehicle, there is populated information such as estimated sales over a last time period (e.g., one month), a projected sales in the next predetermined time period (e.g., one month), an amount of newly listed vehicles over a past predetermined time period (e.g., one month), and an inventory share amongst competitors. FIG. 8A further provides a listing of competing dealers, and for each dealership, providing information such as estimated inventory count, a total estimated sales over last 3 months, a total newly listed vehicles over the last 3 months, and a projected sales over the next predetermined time period (e.g., one month).

In specific use cases, users can include: a Dealership, including such entities as, e.g., general manager, general sales manager, internet sales/business development/consultant; and/or a Dealer Group Corporate Teams, including such entities as, e.g., Director of operations, director of marketing, marketing manager, media specialist. Specific use cases can be oriented to: accelerate turn rate, minimize flooring costs, allocate/stock inventory that is in high demand stretch marketing budgets and content further, gain competitive sales market share and identify merchandising gaps and opportunities.

One example use case scenario is of a dealership general manager who desires access to the auto intelligence dashboard for relevant insights related to their inventory, market dynamics, pricing, incentives and marketing. The dealership can access insights and recommendations within the dashboard 800 of FIG. 8A, e.g., by seamlessly using the AI Agent chat tool within the platform. In this example, the general manager searches, “How can I improve the dealership, what key trends are you seeing and what recommendations on improving my market share?”

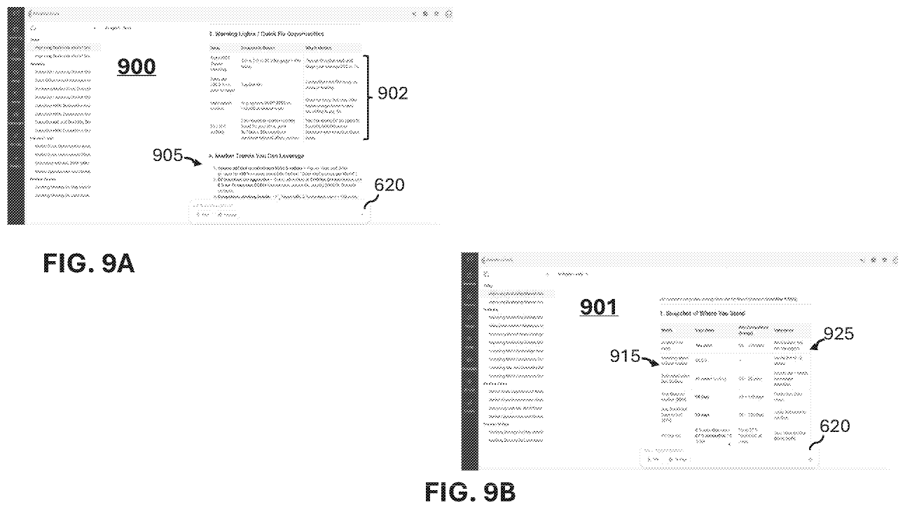

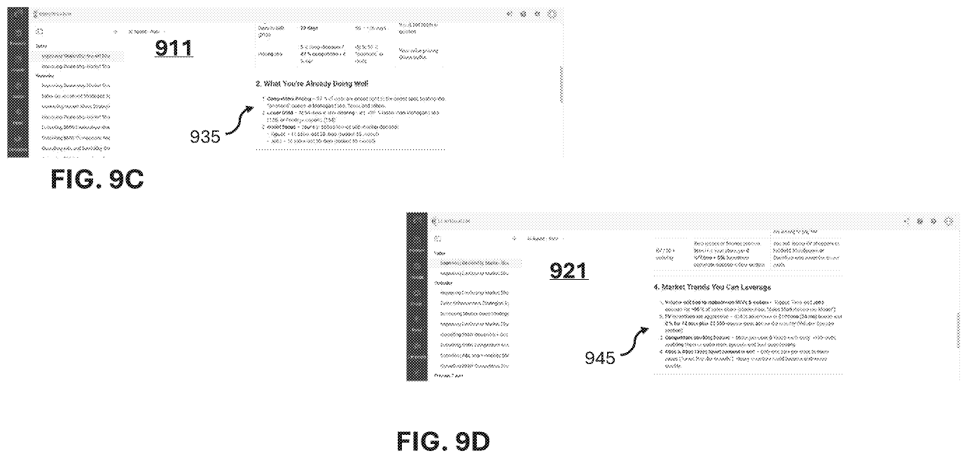

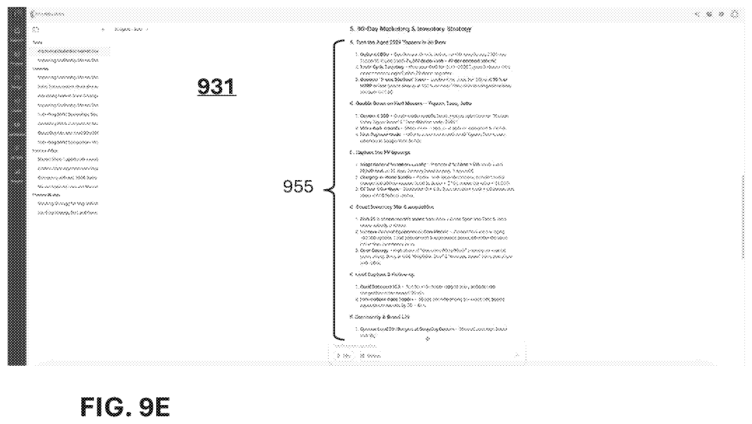

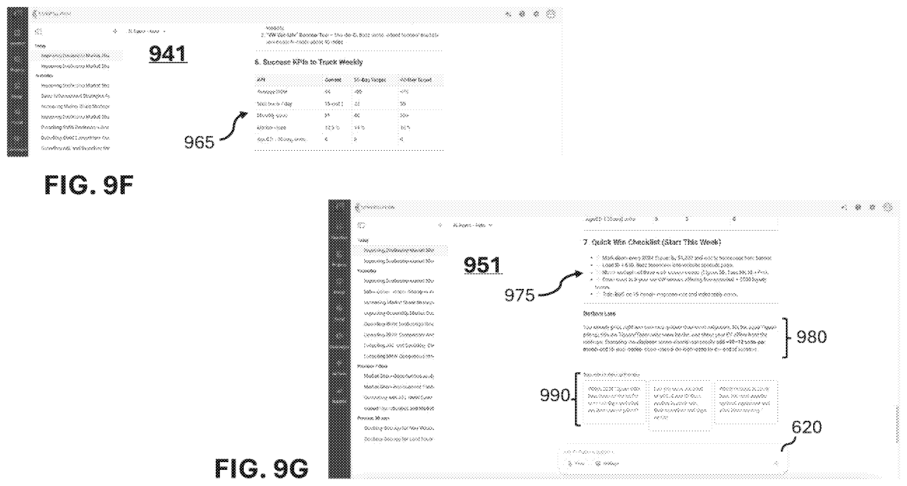

FIG. 8B shows a scorecard presentation 850 depicting the metrics “inventory on hand” 827 “inventory share” amongst local competitors 829 and the specific adjacent result data surfaced for each metric based on data obtained from that specific dealership's store, e.g., shown in FIG. 8A. As shown in the larger example screen view 900 of FIG. 9A, insights can be opened up and presented in this example screen view 900 and the system provides actionable plans for the dealership to inform allocation, marketing decisions, and areas of opportunity to compete with nearby dealerships. For example, based on running method steps depicted in the methodology flow chart of FIGS. 3A-3C, there is generated a screen view 900 of FIG. 9A showing any identified issues, and corresponding evidence in the report that supports these issues and the reason(s) why it matters, and what quick fix opportunities 902 are available and any market trends 905 that the dealership can leverage in hope to obtain an enhanced competitor advantage. For example, the following Table 1 shows a depiction of a portion of the example snapshot of the screen view 900 of FIG. 9A, particularly showing an example of the current quick fix opportunities to enhance a particular car dealership's competitive status based on numbers from an on-brand IQ report. As shown in both FIGS. 9A, 9B, there is surfaced on the user's display a prompt entry input 620 to enable a user to ask the Core AI agent of the system any questions including the downloading of any files or the input of any inquiry.

TABLE 1

| Issue | Evidence in Report | Why It Matters |
|---|---|---|
| Aged 2024 Tiguan | 321 & 137 DOM VINs (page 1 VIN table) | Ties up floorplan cash and drags your |
| inventory | | average DTS to 73. |
| Sales dip (−20.5% vs. | Top-line KPI | Competitors are flat-to-up, so share is |
| prior 30 days) | | leaking. |
| Light option content | Avg. options MSRP $752 vs. >$2,500 at several | Great for price, but may miss |
| | rivals | higher-margin trims buyers are willing to |
| | | pay for. |
| EV/ID.4 visibility | Zero leases or finance promos listed for your store, | You risk losing EV shoppers to Fairfield, |
| | yet 0%/72 mo + $5k incentives dominate national | Middletown or Stamford who advertise |
| | offers section | those deals. |

Further, based on running method steps depicted in the methodology flow chart of FIGS. 3A-3C, FIG. 9B shows an example generated screen view 901 depicting results that the Core AI agent has automatically generated in the form of an action plan 910 for the dealership with concise recommendations-deeply understanding the data and relevance to the dealership's business. The Core AI agent process particularly obtains the corresponding specific values of the metrics 915 for the dealership and provides a comparative range of those values relative to key competitors and generate and surface any key take-aways/recommendations 925 that could benefit the dealership. The following Table 2 shows a depiction of snapshot of the screen view 901 of FIG. 9B, particularly showing an example of the current competitive status of the particular car dealership entity based on numbers from an on-brand IQ report. As shown in both FIGS. 9A, 9B, there is surfaced on the user's display a prompt entry input 620 to enable a user to ask the Core AI agent of the system any questions including the downloading of any files or the input of any inquiry.

TABLE 2

| Metric | Your Store | | Competitors (Range) | | Take-away |
|---|---|---|---|---|---|
| Inventory on hand | 144 | units | 86-170 | units | Solid supply, but not the |
| | | | | | largest. |
| Inventory share in local | 12.3% | | — | | You're 3rd of 10 stores. |
| market | | | | | |
| Estimated sales last 30 | 31 units (−20.5%) | | 25-38 | units | Recent dip - needs |
| days | | | | | immediate attention. |
| Avg. Days-on-Market | 94 | days | 65-153 | days | Faster turn than most. |
| (DOM) | | | | | |
| Avg. Predicted Days-to- | 73 | days | 50-126 | days | Good, but room to quicken. |

| | | | |
|---|---|---|---|
| Sell (DTS) | | | |
| Pricing mix | 8% deep-discount/87% | Up to 97% “premium” at | Your value pricing drives |
| | competitive/4% fair | rivals | traffic. |

FIG. 9C shows a further displayed example screen view 911 depicting results that the Core AI agent has automatically generated in the form of summaries 935 based on the current competitive status for the particular car dealership entity based on data from the on-brand IQ report shown in FIG. 9A. In an example, non-limiting summary, based on running method steps depicted in the methodology flow chart of FIGS. 3A-3C, FIG. 9C screen view 911 shows such data as the dealership's: Competitive Pricing (e.g., indicating 87% of units are priced right in the sweet spot, beating the “premium” stance at Mohegan Lake, Tasca and others; a Lower DOM (e.g., at 94 days you're clearing cars ~30% faster than Mohegan Lake (125) or Prestige Imports (154); a Model Focus of that dealership's top sellers line up with market demand: (e.g., Tiguan—11 sales last 30 days (ranked #5 overall); Jetta—10 sales last 30 days (ranked #8 overall)).

FIG. 9D shows a further displayed example screen view 921 depicting results that the Core AI agent has automatically generated in the form of summaries 945 based on the current market trends that can be leveraged for the particular car dealership entity based on data from the on-brand IQ report shown in FIG. 9A. In a non-limiting example, based on running method steps depicted in the methodology flow chart of FIGS. 3A-3C, FIG. 9D screen view 921 shows such generated data as the dealership's: Volume still tied to mainstream SUVs & sedans (e.g., Tiguan, Taos and Jetta account for >60% of sales share (stacked bar, “Sales Marketshare per Model”)); EV incentives are aggressive (e.g., ID.4 is advertised at $199/mo. (24 mos.) leases and 0% for 72 mos. Plus); a $5,000 finance cash across the country (Vehicle Specials section); and Competitors stocking heavier-Mohegan Lake & Tasca each carry ~170 units, enabling them to claim more eyeballs and lead submissions; and Atlas & Atlas Cross Sport demand is soft (e.g., only one sale per store in many cases (“Least Popular Models”). Heavy inventory could become distressed quickly).

FIG. 9E shows a further displayed example screen view 931 depicting results that the Core AI agent has automatically generated in the form of 90-Day marketing and inventory strategies 955 based on the current market trends that can be leveraged for the particular car dealership entity based on data from the on-brand IQ report shown in FIG. 9A. In a non-limiting example, based on running method steps depicted in the methodology flow chart of FIGS. 3A-3C, FIG. 9E screen view 931 shows such inventory and marketing recommendations such as: 1) Turn the Aged 2024 Tiguans in 30 Days: (e.g., Digital Ad Blitz—Geo-fence a 25-mile radius, run VIN-specific ads (“321-day Tiguan SE R-Line”) with $1,500 dealer cash+90-day payment deferral. Trade-Cycle Targeting—Mine your DMS for 2019-2020 Tiguan & Honda CR-V owners nearing payoff; pitch $0 down upgrades. Weekend “R-Line Blackout” Event—Limited time; price the 2024s at 95% of MSRP or less (you're already at 100% on most VINs; slide to competitive/deep-discount bucket); 2) Double Down on Fast Movers:—Tiguan, Taos, Jetta (e.g., Content & SEO—Create model-specific landing pages optimized for “Hudson Valley Tiguan lease” & “Taos 4Motion under $300; Video Walk-arounds—Shoot 60-sec reels; post daily on Instagram & TikTok; First—Payment Credit-Offer to cover first month on all Tiguan/Taos leases; advertise in Google Vehicle Ads); 3) Capture the EV Upsurge: (e.g., Adopt National Incentives Locally—Promote 0%/72 mo+$5 k on ID.4 and $7,500 cash on ID. Buzz (already listed on page 1 specials). Charging-at-Home Bundle—Partner with local electricians; include Level-2 charger installation voucher (cost to dealer≈$750; marketing value≈$1,500). EV Test-Drive Week—Dedicated ID.4 & ID. Buzz test-drive track+education tent about NYS & federal credits; 4) Smart Inventory Mix & Acquisition: (e.g., Shift 20% of next month's orders from Atlas/Cross Sport into Taos & Jetta where velocity is strong. Increase Optional Equipment on Core Models—Competitors are averaging ~$2,000 options. Load popular tech & appearance packs; advertise the value rather than bare-bones units; Color Strategy—High share of “Unknown/White/Black” showing on your lot (color chart). Bring in bold “Kingfisher Blue” & “Avocado Green” trims that photo well online); 5) Lead Capture & Follow-up: (e.g., Rapid Response SLA—Aim for <10-minute reply to every website lead; competitors often exceed 30 min; Personalized Video Replies—60-sec clip referencing the exact VIN; boosts appointment set-rate by 30-40%; and 6) Community & Brand Lift: (e.g., Sponsor Local EV Chargers at Shopping Centers—Minimal cost, high brand visibility. “VW Van-Life” Summer Tour—Use the ID. Buzz demo; attend farmers' markets and music festivals within 40 miles).

In a further non-limiting example, based on running method steps depicted in the methodology flow chart of FIGS. 3A-3C, FIG. 9F shows a further displayed screen view 941 depicting results that the Core AI agent has automatically generated in the form of successful key performance indicators (KPIs) 965 that is recommended to be tracked periodically, e.g., weekly, for the particular car dealership entity based on data from the on-brand IQ report shown in FIG. 9A. Table 3 shows a depiction of snapshot of the screen view 941 of FIG. 9F, particularly showing an example of the successful KPIs recommended to be tracked weekly with current day targets, 30-day targets and 90-day targets.

TABLE 3

| KPI | Current | 30-Day Target | 90-Day Target |
|---|---|---|---|
| Average DOM | 94 | <85 | <75 |
| Web leads/day | 18 (est.) | 25 | 35 |
| Monthly sales | 31 | 40 | 50+ |
| Market share | 12.3% | 14% | 16% |
| Aged (>120-day) units | 8 | 3 | 0 |

FIG. 9G shows a further displayed screen view 951 depicting results that the Core AI agent has automatically generated in the form of a “Quick Win” checklist strategies 975 based on the current market trends and KPIs that can be leveraged for the particular car dealership entity that can help its bottom line. In a non-limiting example, based on running method steps depicted in the methodology flow chart of FIGS. 3A-3C, FIG. 9G screen view 951 shows such recommendations such as: 1) Marking down every 2024 Tiguan by $1,000 and add to homepage hero banner; Loading ID.4 & ID. Buzz incentives into website specials page; Shooting and uploading three walk-around videos (Tiguan SE, Taos SE, ID.4 Pro); Sending e-mail blasts to 3-year-old VW owners offering free appraisal+$500 loyalty bonus; Training BDC on 10-minute response rule and video reply script.

As further shown in FIG. 9G, the Core AI agent can also generate a “Bottom Line” message with immediate action to be taken and resulting benefits. A non-limiting example of a “Bottom Line” screen message 980 of FIG. 9G can state that the dealership already prices right and turns cars quicker than most neighbors and that the dealership is recommended to fix the aged Tiguan pile-up, to ride the Tiguan/Taos/Jetta wave harder, and to shout EV offers from the rooftops. Executing the playbook above should realistically add +10-12 units per month and lift that dealership's market share toward the high-teens by the end of summer.

As further shown in FIG. 9G, the Core AI agent can also generate via screen display view 951 of FIG. 9G any follow up prompts 990 that the user can select and that are included for users to easily continue finding relevant information.

In additional, non-limiting embodiments, a vehicle dealership can exercise additional prompts to generate additional relevant information as it pertains to attaining/maintaining market share, stocking/allocating decisions and general recommendations for the dealership versus a competitor. Dealership use cases/prompts can be surfaced and queried by the dealership to generate queries results pertaining to market share with respect to specific dealer entities to answer questions such as: 1) How can I improve the dealership, what key trends are you seeing and what recommendations on improving my market share? 2) How can I beat [competing dealer]?; 3) What are ways I can gain market share against my local [on brand or conquest] competitors?; 4) Given my current supply, how can I sell more cars against the biggest [on brand or conquest] dealer in my market?; Give me recommendations on how to increase my sales when compared to my nearby competitors?; How does my market share look as opposed to my competitors and what color vehicles should I allocate my dealership with?; What are the best ways to boost sales and what are my most competitive offers against other brands?; How can I outsell <Competitor 1> and <Competitor 2>? What trends are we seeing for those 2 stores with how they are allocating inventory and installed options compared tome? What strategies can I implement to increase market share for the <Model> and outperform <Competitor>?

As a further example, a dealership can use the system to surface prompts and generate queries/results pertaining to inventory stocking/allocation by answering questions such as but not limited to: 1) Provide a color/trim ordering playbook for the next 90 days to outsell my competitors. Include the percent allocation for each combination I should order to have the lowest days to sell in my market along with concise action items; 2) How are my competitors stocking inventory based on color and how does this compare with my inventory allocation? How can I stock my inventory based on the market to reduce my overall days to sell? 3) What steps can we take in terms of inventory allocation, stocking strategy, and ordering decisions to ensure my dealership <My Dealership> is better positioned than <Competitor> in meeting local demand and capturing market share? What insights do we have on <Competitor>'s top-selling models or volume movers, and how can we adjust our mix to counter that?

As a further example, a dealership can use the system to surface prompts and generate queries/results pertaining to general recommendations, or actionable plans for managing inventory, including but not limited to: How do you think my inventory mix is and what are some things I should be looking for in terms of allocating my vehicles when compared to my competitors? Based on what you see, how can I improve my sales compared to my competitors? What areas should I focus on against off-brand competitors? Provide a specific “on brand” or “conquest” insights focused on the particular dealership (e.g., dealer name), or specifically a dealer website. Thus, the software agent can recommend an actionable plan such as an allocation scheme for allocating vehicles as compared to a competitor's vehicle allocation.

The Core AI Agent system and methodology described herein can leverage 98% of VIN specific inventory data in the US/Canada. Every car's vehicle identification number (VIN) is tracked which is the identifying code for a specific automobile. The VIN serves as the car's fingerprint, as no two vehicles in operation have the same VIN. The platform also generates several key insights including, but not limited to: Vehicle Year, Make, Model and Trim (YMMT); Configuration options of specific vehicles like rim types, technology and additional specifications; Listing activity when vehicles enter and exit dealership websites; Inventory that is considered “aged” which can indicate loss of profit over a specified number of days the vehicle sits at a dealership; Relative insights with competitive inventory other nearby dealerships possess; Predictive Days to Sell (DTS) data model that identifies the duration a vehicle is anticipated to sell based on market dynamics, pricing, and historical trends (e.g., historical sales trends for the vehicles e.g., based on past market conditions). Other key insights produced by the platform include additional models producing various business insights such as: a Days to Sell (this includes priority score) (e.g., New for US; Used for US); a Pricing Categorization: (e.g., New and Used); a Demand Forecasting; a Flooring Cost model (e.g., a predictive model configured to predict a cost for stocking vehicles, e.g., predict a stocking strategy for stocking types and amounts of vehicles in areas of the dealership location/floor for presentation to consumers for viewing within a sales location; Lease Penetration model; EV model; Used model.

With respect to model functionality, a training architecture of the vehicle DTS prediction model 474, FIG. 4F addresses: 1) how to generate the new training data, and 2) how is the architecture of the training model.

With respect to training the DTS prediction model training data, the most important task for model retraining is the specifying a reasonable range of training data for the DTS model. Since a number of high-quality labels is needed, the system usually keeps the latest period out of consideration for model retraining (e.g., because these vehicles are very likely not to be sold). Based on an example data distribution report, some final decisions can be made:

Given a distribution report over a target period (e.g., 5 months), there is a range of target data (0-100 days) over a target period; Vehicles with in-transit label (in-transit depends on the first status) are removed. There is devised a Training data set: 80%, and a Test data set: 10%, and Validation data set: 10%. Data can include, but not limited to: Numerical data, Categorical data, Location data, and Sales data.

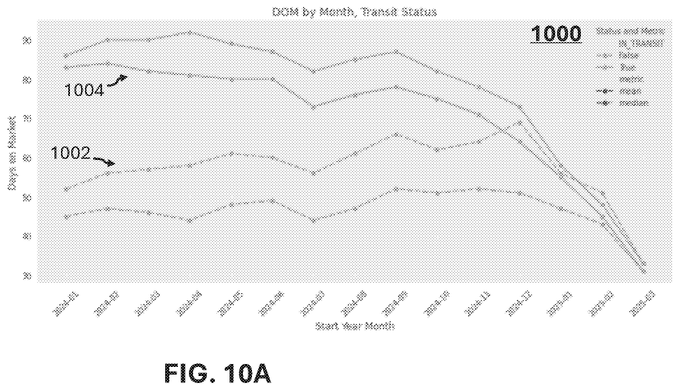

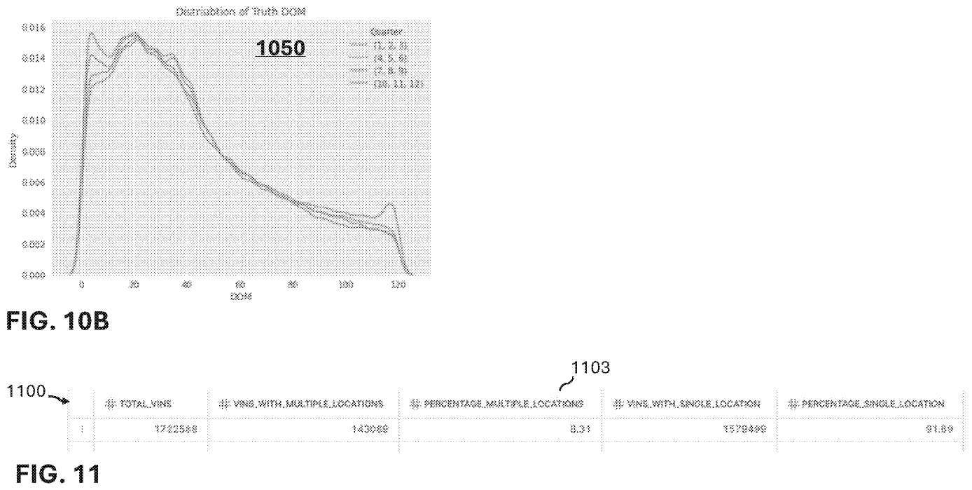

FIG. 10A shows a chart of example data used for training the DTS machine-learned model used to predict a duration a vehicle item will be purchased based on one or more of: a state of the current market for the vehicle, a pricing of the vehicle, and a historical trend. In FIG. 10A, a plot 1000 is depicted including data representing a number of days on the market (“DOM”) (e.g., by month) (Y-axis) for a vehicle as a plot against a current listing period (e.g. an elapsed time along the X-axis). From chart 1000, there can be determined various indicators such as the cumulative days on the market, a state of the market or market trends such as low DOM 1002 which can indicate a strong marketer suggesting strong buyer interest or higher DOMs 1004 which can indicate less demand for the vehicle or overpricing, which trends can help in making informed decisions for the dealership to become more competitive, e.g., by reducing prices.

FIG. 10B depicts a plot 105 showing a distribution of the truth DOM for different time periods, i.e., quarterly, and particularly a density (Y-Axis) plotted against the DOM (X-axis) for a vehicle(s).

For most features, a median or mode represents a vehicle identification number (VIN)-level feature. To improve the quality of training data, the construction of training data can include:

### For Numerical Data:

Instead of just taking the average value of most numerical features, the variety of features is expanded. For example, for price, the min, max, standard deviation, mean and median can be taken to enrich the information about price. Another specific function is also designed to build more features related to these numerical features, such as MPG (miles/gallon) difference to show the difference between city MPG and highway MPG. For filling missing values, the level can be increased by adding NEO_TRIM as part of the group by for first level. Thus, in an embodiment, the filling of missing values can look like:
NEO_YEAR, NEO_MAKE, NEO_MODEL, NEO_TRIM
NEO_YEAR, NEO_MAKE, NEO_MODEL
NEO_YEAR, NEO_MAKE
NEO_MAKE
Global level

For NEO_DOORS and NEO_YEAR, a “mode” can be used to fill the missing values and for other numerical features, the median can be used to fill in missing values.

### For Categorial Data:

For categorical data, the main processing is the same but the logic of filling missing values is slightly changed. For most features, there is taken a hierarchical imputation strategy starting from filling numbers by the mode of the same group of make and model, then make only. For color, there is only taken the first layer of imputation and for “Carfax” features, since new vehicles typically have clean titles and are first owners, both are filled in True.

### For Location Data:

As shown in FIG. 11, there is the depiction of adding additional location data 1100 for vehicle identifiers (specific VINs), including, but not limited to: an initial_location, last_location and a count of the number of locations of each vehicle for this feature (e.g., VINs with multiple locations, VINs with single location, etc.). As an example, running a quick test for the percentage of vehicles that have multiple locations for the latest status date, there is shown an example result 1103 of approximately 8%. Other features for vehicles and the manner of their processing include, but is not limited to: a LOWEST_PRICE (processed as a Minimum of price); a HIGHEST_PRICE (processed as a Maximum of price); a MEDIAN_PRICE (processed as a Median of price); an AVG_PRICE (processed as an Average value of price); a PRICE_STDDEV (processed as a Standard deviation of price); a PRICE_CHANGE_PCT

$$( processed according to \frac{( Maximum of price - Minimum of price )}{Minimum of price} )$$

a NEO_CITY_MPG and a NEO_HIGHWAY_MPG (processed as a median value); an AVG_COMBINED_MPG

$$( processed according to AVG \frac{( {NEO}_{{CITY}_{MPG}} + NEO\_HIGHWAY \_MPG )}{2} ) ;$$

a NEO_YEAR and a NEO_DOORS (both processed as a mode); a NEO_WEIGHT, a NEO_HEIGHT, a NEO_LENGTH, a NEO_WIDTH, and a NEO_INSTALLED_OPTIONS_MSRP (all processed as a median value); a DEALER_COUNT (processed as the number of different dealers that own the vehicle); a NEO_MAKE, a NEO_MODEL, a NEO_TRIM, a VEHICLE_TYPE, a NEO_DRIVETRAIN, a NEO_POWERTRAIN_TYPE, a NEO_FUEL_TYPE, a NEO_ENGINE, a NEO_TRANSMISSION, a BASE_EXTERIOR_COLOR, a BASE_INTERIOR_COLOR, a CARFAX_1_OWNER, a CARFAX_CLEAN_TITLE and a NEO_HIGH_VALUE_FEATURES (all processed as a mode value); NUM_LOCATIONS (processed as the number of different locations the vehicle appears); an INITIAL_CITY (processed as the first city the vehicle is located); an INITIAL_STATE (processed as the first state the vehicle is located); a CURRENT_CITY (processed as the last city the vehicle is located); and a CURRENT_STATE (processed as the last state the vehicle is located).

### For Sales Data:

As part of the features, in an embodiment, sales data is not used in tree-based models but it is very important for deep learning models. There is particularly introduced more features based on sales data such as: 1) an Inventory turnover which, in an embodiment, can be computed according to:

$$\frac{( sales for this week - sales for last week )}{sales on weekly basis} ;$$

2) Market share: sales percentage among the whole market on weekly basis; and 3) a Current State+Make. Model Architecture:

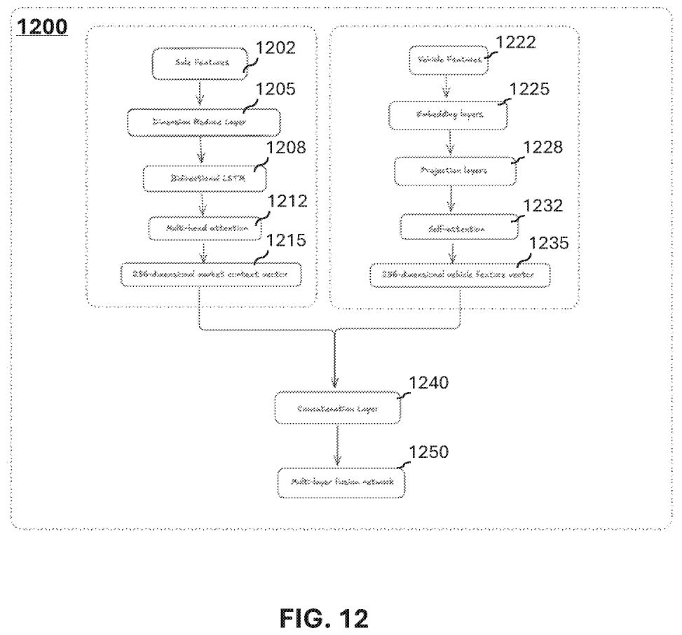

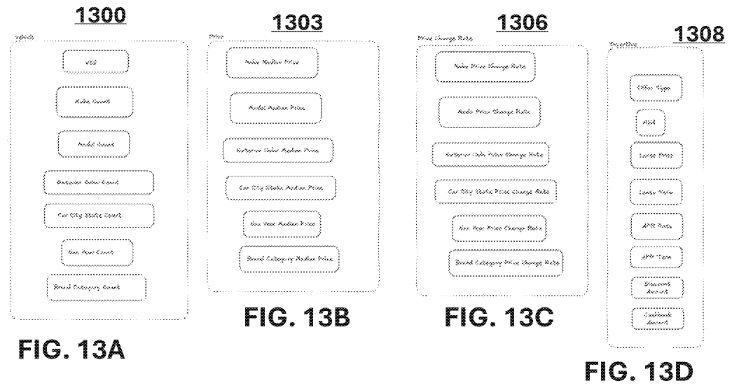

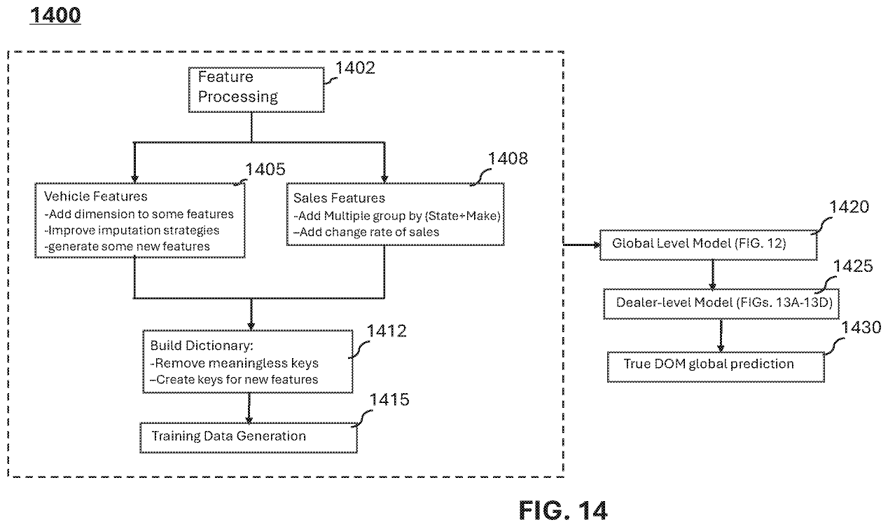

In an embodiment, FIG. 12 depicts an example two-tower DTS prediction model architecture in an example embodiment. As shown in FIG. 12, an exemplary model architecture that is trained to predict a DTS of vehicles is a two-part model architecture. The two-tower model, as the global-level model, helps to predict the DTS of every vehicle on the market. Since the requirement of training data to retrain this model is strict, it is suggested that this model be retrained periodically, e.g., every 4-6 months.

In an embodiment, as shown in FIG. 12, the DTS prediction model 1200 is trained based on input sales features 1202. The model includes layers for reducing data dimension at 1205, and a bidirectional long short term memory (LSTM) processing ensures the ability to capture long-term dependencies in sequential data for time series forecasting. To capture more diverse data relationships and patterns, a multi-headed attention process is run at 1212 to split the inputs into multiple heads. For example, as a result of multi-headed attention processing at 1212, there can be generated at 1215 a 256-dimensional market context vector output. In the second tower of the model, the DTS prediction model 1200 is further trained based on input vehicle features 1222. Further model processing includes: the embedding of further layers at 1225, the projection layers 1228 and a further self-attention process that is run at 1232. As a result of self-attention processing at 1232, there can be generated at 1235 a 256-dimensional vehicle feature vector output. Both 256-dimensional market context vector output generated at 1215 and the 256-dimensional vehicle feature vector output generated at 1235 form concatenation layer at 1240 and ultimately, a multi-layer fusion network is generated at 1250.

In an embodiment, for each dealer, there is still sufficient information that has to be decoded to get a more accurate result of prediction. Thus, a second part of the model would be a specific dealer model designed for each dealer, which focuses on dealer-level features. In an embodiment, incentive data can be integrated into this model which is not included in the first part of the model. Since this model requires the latest incentive data and dealer-related features and not a high price to retrain, it is suggested to retrain on a monthly basis.

FIGS. 13A-13D depict the various dealer level features that can be input to train the DTS model including the procuring of a ground truth days on market (DOM) value used for generating a dealer-level model for global prediction.

For example, FIG. 13A depicts the vehicle feature data that can be used to train the DTS prediction model in an embodiment. As shown, vehicle feature data 1300 can include, but is not limited to: the VIN of the vehicle, a make count, a model count, an exterior color count, a car/city/state count; a Neo year count; and a Brand Category count.

FIG. 13B depicts the vehicle pricing data that can be used to train the DTS prediction model in an embodiment. As shown, vehicle pricing data 1303 can include, but is not limited to: the median price for the vehicle make, the median price of the model, the median price for a model of a specific exterior color a car/city/state median price, a Neo year median price; and a median price of a brand category.

FIG. 13C depicts the vehicle pricing change rate data that can be used to train the DTS prediction model in an embodiment. As shown, vehicle change rate pricing data 1306 can include, but is not limited to: the price change rate for the vehicle make, a price change rate of the model, a specific exterior color price change rate, a car/city/state price change rate, a Neo year price change rate; and a brand category price change rate.

FIG. 13D depicts the incentive data that can be used to train the DTS prediction model in an embodiment. As shown, purchase incentive data 1308 can include, but is not limited to: an offer type, an MSA, a lease price, a lease term, an APR rate, an APR term, and a discount amount.

FIG. 14 depicts a flow methodology 1400 for model development. As shown in FIG. 14, there is performed a first feature processing step 1402. This step performs operations including the obtaining and processing of the vehicle features at 1405 and, in parallel, the obtaining and processing of sales features at 1408. The processing of vehicle features at 1405 includes operations to add dimensions to some vehicle features. Further, at 1405, the processing includes the improving of imputation strategies and the generating of some new features. Further, the processing of sales features at 1408 includes operations to add multiple groups by “State” and vehicle “Make” and to add change rate of sales information. Continuing to 1412, the next step includes the building of a dictionary including operations performed to remove meaningless keys and to create keys for new features. Then, continuing to 1415. FIG. 14, there is performed the generation of the training data. The generated training data is used as input to generate the global-level two-tower DTS prediction model as depicted by the example processes shown in FIG. 12. This step 1420 is followed by a step 1425 involving the procuring of the dealer-level model as shown using the data processing of FIGS. 13A-13D that result in obtaining the true DOM global prediction model as shown at 1430, FIG. 14.

The system and methodology provide a multi-agent AI system that connects consumers and dealerships in an efficient, automated ecosystem. The core AI agent facilitates analytics, content generation, and workflow automation. Powerful design tools use templates and data to scale content creation capabilities. Marketing Orchestration provides for multi-channel marketing deployment and management. The system allows for integration of vertical specific extensions including training on vertical or client specific data sets, business rules, or tech integrations to client-specific tools/software

With respect to content creation, there is further provided a Content Automation system that is an AI-orchestrated, multi-channel marketing asset engine that automatically transforms business data, inventory information, brand rules, and compliance constraints into ready-to-publish HTML, image, and video assets at enterprise scale. The platform includes content generation and marketing automation agent components such as: 1) a no-code templating engine (image, video, HTML) driven by AI; 2) a multi-source data unification layer that binds templates to live data feeds; 3) an AI compliance engine that automatically enforces OEM, brand, and legal rules; 4) an AI decisioning for selecting inventory, incentives, offers, and creative elements; 5) an End-to-end automated asset creation, preview, QC, and approval workflows; and 6) an automatic deployment of assets to websites, ad platforms, and external systems. These components operatively create a fully autonomous content production loop, minimizing manual steps and ensuring compliant, personalized marketing output at massive scale.

An AI-driven template creation and management platform further provides a unified template design environment supporting image, video, and HTML asset formats. Such creation and management platform perform operations to: 1) Import or create HTML, video, and image templates using a no-code designer with drag-and-drop components; 2) employ an AI-powered layout and resizing engine that automatically adapts templates to any required dimension or aspect ratio; 3) employ a bulk editing across hundreds of templates simultaneously; 4) provide automated compliance suggestions (fonts, colors, positioning, terminology) based on OEM and brand rules; and 5) provide AI template testing, which dynamically populates data variants to validate template robustness before publishing.

A further multi-source data integration and personalization logic platform provides a template-driven, context-aware data orchestration, unifying multiple sources. This platform performs operations to: 1) Ingest, in real-time, MarketScan, Marketcheck, custom feeds, dealer/inventory APIs, and internal datasets; 2) employ Multi-source templates that can request data from multiple sources simultaneously; 3) employ template-driven input prompts: the template defining exactly what data is required; and 4) employ flexible data entry flows that adapt to the template and campaign type.

A further fully automated AI compliance enforcement engine is employed to automatically enforce OEM, legal, and brand guidelines. This platform performs operations to: 1) Automate the formatting of vehicle names, trims, pricing, and copy; 2) provide AI-driven adjustment of layout and font treatments to maintain brand correctness; 3) provide for automatic generation, versioning, and placement of disclaimers; and 4) provide integrated co-op submission workflows with validation.

A further AI-powered inventory, offer, and campaign selection system intelligently determines what should be marketed. This intelligent selection system is configured with capability to: 1) use AI to analyze inventory, sales velocity, incentives, and regional data to surface the optimal vehicles/offers; 2) automate selection of offer type (lease, finance, cash) based on expected performance; 3) employ an integrated incentive calculator with real-time re-computation; 4) employ dynamic VIN and incentive selection based on user-defined filters.

Further functionality provides for automated assignment of visual elements with visual creative components being automatically sourced, mapped, and validated. Key Features include but are not limited to: 1) AI recommending optimal backgrounds, logos, lifestyle assets, and visual treatments per OEM/model; 2) provide for an automated mapping of lifestyle images to models in a single project; and 3) automatically match branding assets to OEM or dealer-level branding rules.

Further functionality provides for Multi-Rooftop, Multi-Format Asset Generation including the generation of marketing assets at a massive scale. Key Features include but are not limited to: 1) Simultaneous generation of HTML, image, and video assets; 2) Multi-rooftop support: one project can output thousands of assets across dozens of dealer locations; 3) provide an enhanced rendering pipeline for outputting high-resolution, publish-ready assets.

Further functionality provides for Rich Asset Preview, Quality Control (QC), and inline editing. Key Features include but are not limited to: 1) provide high-fidelity previews with full-screen rendering and zoom; 2) provide for inline, real-time edits to data and layout directly from preview mode; and 3) provide filtering, grouping, and batch-approval tools for QA teams.

Further functionality provides for automated multi-channel deployment with key features including but are not limited to: 1) asset mapping to websites, landing pages, email modules, and specific placement zones; 2) automatic updating of placements via CMS/API (Ad Shell, dealer websites); 3) provide a full external API for third-party system integration; and 4) provide automatic version updates when incentives or inventory change.

Further functionality provides for collaboration, approvals, and project governance. Key Features include but are not limited to: 1) task assignment, notifications, audit trails, and user-based permissions; 2) provide a real-time chat at the project or asset level; 3) provide markup-based review stages with bulk approval/denial; and 4) share global settings and reusable elements across enterprise teams.

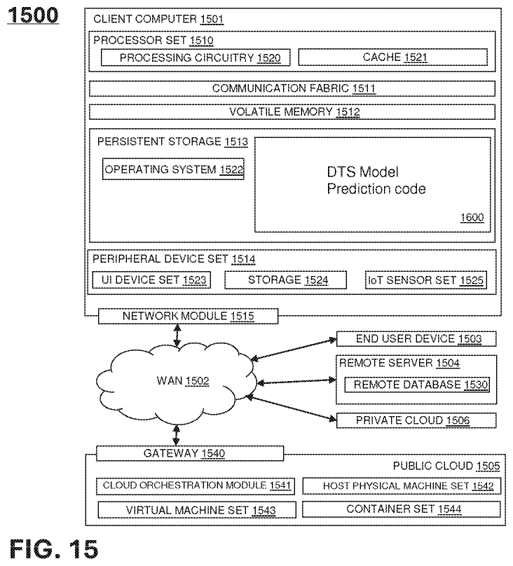

FIG. 15 shows an example of a computing environment 1500, which can implement the intelligent multi-agent AI platform of FIGS. 1-2 in accordance with an embodiment of the present disclosure.

Computing environment 1500 contains an example of an environment for the execution of at least some of the computer code involved in performing the inventive methods, such as software code 1600 that is used to run the methods 1200 of FIG. 12 for performing a DTS prediction used for dealerships to manage their inventories and allotments of vehicles thereto. In addition to block 1600, computing environment 1500 includes, for example, computer 1501, wide area network (WAN) 1502, end user device (EUD) 1503, remote server 1504, public cloud 1505, and private cloud 1506. In this embodiment, computer 1501 includes processor set 1510 (including processing circuitry 1520 and cache 1521), communication fabric 1511, volatile memory 1512, persistent storage 1513 (including operating system 1522 and block 1600, as identified above), peripheral device set 1514 (including user interface (UI) device set 1523, storage 1524, and Internet of Things (IOT) sensor set 1525), and network module 1515. Remote server 1504 includes remote database 1530. Public cloud 1505 includes gateway 1540, cloud orchestration module 1541, host physical machine set 1542, virtual machine set 1543, and container set 1544.

COMPUTER 1501 may take the form of a desktop computer, laptop computer, tablet computer, smart phone, smart watch or other wearable computer, mainframe computer, quantum computer, distributed computer system, or any other form of computer or mobile device now known or to be developed in the future that is capable of running a program, accessing a network or querying a database, such as remote database 1530. As is well understood in the art of computer technology, and depending upon the technology, performance of a computer-implemented method may be distributed among multiple computers and/or between multiple locations. On the other hand, in this presentation of computing environment 1500, detailed discussion is focused on a single computer, specifically computer 1501, to keep the presentation as simple as possible. Computer 1501 may be located in a cloud, even though it is not shown in a cloud in the figures. On the other hand, computer 1501 is not required to be in a cloud except to any extent as may be affirmatively indicated.

PROCESSOR SET 1510 includes one, or more, computer processors of any type now known or to be developed in the future. Processing circuitry 1520 may be distributed over multiple packages, for example, multiple, coordinated integrated circuit chips. Processing circuitry 1520 may implement multiple processor threads and/or multiple processor cores. Cache 1521 is memory that is located in the processor chip package(s) and is typically used for data or code that should be available for rapid access by the threads or cores running on processor set 1510. Cache memories are typically organized into multiple levels depending upon relative proximity to the processing circuitry. Alternatively, some, or all, of the cache for the processor set may be located “off chip.” In some computing environments, processor set 1510 may be designed for working with qubits and performing quantum computing.

Computer readable program instructions are typically loaded onto computer 1501 to cause a series of operational steps to be performed by processor set 1510 of computer 1501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1521 and the other storage media discussed below. The program instructions, and associated data, are accessed by processor set 1510 to control and direct performance of the inventive methods. In computing environment 1500, at least some of the instructions for performing the inventive methods may be stored in block 1600 in persistent storage 1513.

COMMUNICATION FABRIC 1511 is the signal conduction path that allows the various components of computer 1501 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1512 is any type of volatile memory now known or to be developed in the future. Examples include dynamic type random access memory (RAM) or static type RAM. Typically, volatile memory 1512 is characterized by random access, but this is not required unless affirmatively indicated. In computer 1501, the volatile memory 1512 is located in a single package and is internal to computer 1501, but, alternatively or additionally, the volatile memory may be distributed over multiple packages and/or located externally with respect to computer 1501.

PERSISTENT STORAGE 1513 is any form of non-volatile storage for computers that is now known or to be developed in the future. The non-volatility of this storage means that the stored data is maintained regardless of whether power is being supplied to computer 1501 and/or directly to persistent storage 1513. Persistent storage 1513 may be a read only memory (ROM), but typically at least a portion of the persistent storage allows writing of data, deletion of data and re-writing of data. Some familiar forms of persistent storage include magnetic disks and solid state storage devices. Operating system 1522 may take several forms, such as various known proprietary operating systems or open source Portable Operating System Interface type operating systems that employ a kernel. The code included in block 1600 includes at least some of the computer code involved in performing the inventive methods.

PERIPHERAL DEVICE SET 1514 includes the set of peripheral devices of computer 1401. Data communication connections between the peripheral devices and the other components of computer 1501 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 1523 may include components such as a display screen, speaker, microphone, wearable devices (such as goggles and smart watches), keyboard, mouse, printer, touchpad, game controllers, and haptic devices. Storage 1524 is external storage, such as an external hard drive, or insertable storage, such as an SD card. Storage 1524 may be persistent and/or volatile. In some embodiments, storage 1524 may take the form of a quantum computing storage device for storing data in the form of qubits. In embodiments where computer 1501 is required to have a large amount of storage (for example, where computer 1501 locally stores and manages a large database) then this storage may be provided by peripheral storage devices designed for storing very large amounts of data, such as a storage area network (SAN) that is shared by multiple, geographically distributed computers. IoT sensor set 1525 is made up of sensors that can be used in Internet of Things applications.

NETWORK MODULE 1515 is the collection of computer software, hardware, and firmware that allows computer 1501 to communicate with other computers through WAN 1502. Network module 1515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1515 are performed on the same physical hardware device. In other embodiments (for example, embodiments that utilize software-defined networking (SDN)), the control functions and the forwarding functions of network module 1515 are performed on physically separate devices, such that the control functions manage several different network hardware devices. Computer readable program instructions for performing the inventive methods can typically be downloaded to computer 1501 from an external computer or external storage device through a network adapter card or network interface included in network module 1515.

WAN 1502 is any wide area network (for example, the internet) capable of communicating computer data over non-local distances by any technology for communicating computer data, now known or to be developed in the future. In some embodiments, the WAN 1502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1503 is any computer system that is used and controlled by an end user (for example, a customer of an enterprise that operates computer 1501), and may take any of the forms discussed above in connection with computer 1501. EUD 1503 typically receives helpful and useful data from the operations of computer 1501. For example, in a hypothetical case where computer 1501 is designed to provide a recommendation to an end user, this recommendation would typically be communicated from network module 1515 of computer 1501 through WAN 1502 to EUD 1503. In this way, EUD 1503 can display, or otherwise present, the recommendation to an end user. In some embodiments, EUD 1503 may be a client device, such as thin client, heavy client, mainframe computer, desktop computer and so on.

REMOTE SERVER 1504 is any computer system that serves at least some data and/or functionality to computer 1501. Remote server 1504 may be controlled and used by the same entity that operates computer 1501. Remote server 1504 represents the machine(s) that collect and store helpful and useful data for use by other computers, such as computer 1501. For example, in a hypothetical case where computer 1501 is designed and programmed to provide a recommendation based on historical data, then this historical data may be provided to computer 1501 from remote database 1530 of remote server 1504.

PUBLIC CLOUD 1505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1505 is performed by the computer hardware and/or software of cloud orchestration module 1541. The computing resources provided by public cloud 1505 are typically implemented by virtual computing environments that run on various computers making up the computers of host physical machine set 1542, which is the universe of physical computers in and/or available to public cloud 1505. The virtual computing environments (VCEs) typically take the form of virtual machines from virtual machine set 1543 and/or containers from container set 1544. It is understood that these VCEs may be stored as images and may be transferred among and between the various physical machine hosts, either as images or after instantiation of the VCE. Cloud orchestration module 1541 manages the transfer and storage of images, deploys new instantiations of VCEs and manages active instantiations of VCE deployments. Gateway 1540 is the collection of computer software, hardware, and firmware that allows public cloud 1505 to communicate through WAN 1502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1506 is similar to public cloud 1505, except that the computing resources are only available for use by a single enterprise. While private cloud 1506 is depicted as being in communication with WAN 1502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1505 and private cloud 1506 are both part of a larger hybrid cloud.

CLOUD COMPUTING SERVICES AND/OR MICROSERVICES (not separately shown in FIG. 15): private cloud 1506 and public clouds 1505 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer system for optimized data retrieval, the system comprising:
a processor set;
one or more computer-readable storage media;
program instructions stored on the one or more computer-readable media to cause the processor set to perform operations comprising:
receiving a natural language (NL) query from a chat interface, the NL query requesting information used to facilitate performing a task, the information available from one or more distributed data storage systems available to multiple parties;
accessing a software agent used to interpret the NL query; and
generating, by the software agent, instruction signals based on said interpreted NL query, said instruction signals used to automatically access information from said one or more data storage systems in performing the task, wherein the generated signals comprise one or more signals distributed to the one or more data storage systems and used to dynamically access data for efficient task performance, and one or more signals used to access at least one machine-learned model (ML-model) trained to generate insights regarding the task to be performed;
generating, using said trained ML-Model, one or more insights associated with the task to be performed, said software agent using said generated insights to access the most accurate data from the distributed data storage systems for optimized task performance; and
presenting, to the user, via chat interface, said accessed data that optimizes, for the user, the task being performed.

2. The computer system of claim 1, wherein the task performed is associated with a potential purchase of an item by the user, a data storage system comprising an inventory of items for the potential user purchase, and the one or more instruction signals used to access information from said inventory associated with the potential user purchase.

3. The computer system of claim 2, wherein the at least one ML-model generates first insights based on a criteria for item purchase based on prior received queries from the user or previous interactions with the user, the software agent responsive to said first insights for generating signals used to access relevant inventory and data related to an inventory item for potential user purchase.

4. The computer system of claim 3, wherein the criteria for item purchase based on prior received queries from the user comprises: a potential budget for item purchase, a preferred location for potential item purchase, a specific entity or brand providing the potential item for purchase.

5. The computer system of claim 4, wherein the ML-model generates said first insights based on prior user behavior, a saved search for an item and previous items viewed by the user in said saved searches.

6. The computer system of claim 4, wherein the software agent is responsive to said first insights for generating one or more recommendations regarding the potential purchase of another item for potential user purchase and presenting said one or more recommendations to the user.

7. The computer system of claim 6, wherein the operations further comprise:
obtaining a listing of items from inventories stored in distributed data storage systems associated with multiple distributed sources;
aggregating said inventory listings of items from the multiple distributed sources, said aggregating comprising synchronizing and normalizing said listing of items; and
presenting, via the chat interface, the aggregated and normalized listing of items for user viewing and item selection.

8. The computer system of claim 7, wherein one or more of the multiple sources comprise a seller of the item, said operations further comprise:
receiving, from said chat interface, a lead comprising a user selection of an item from said aggregated inventory listing of items;
matching, by said software agent, the received user lead with one or more potential sellers of the item, said matching based on an item availability in said source inventory and a current demand for said item by other querying users; and
forwarding, by said software agent, one or more instruction signals to each matched seller, said instruction signals requesting a quote or bid from the seller for the potential item purchase by the user.

9. The computer system of claim 8, wherein said operations further comprise:
receiving, by the software agent, from each of the one or more potential sellers, a respective seller bid or quote associated with the user purchase of the item;
presenting, via said chat interface, each respective seller bid or quote associated the potential item for purchase by said user.

10. A computer system comprising:
a processor set;
one or more computer-readable storage media;
program instructions stored on the one or more computer-readable media to cause the processor set to perform operations comprising:
receiving, from each of a plurality of multiple distributed sources, a respective listing of an inventory of items;
aggregating, by a software agent, each received inventory listings of items from each respective source of the multiple distributed sources;
receiving, from a user, a NL query associated with a managing of the items of an inventory for a respective source of the multiple distributed sources;
accessing the software agent to interpret the NL query; and
running, by the software agent, in response to the NL query, at least one machine-learned model (ML-model) trained to generate insights regarding the inventory of items received from the respective source;
generating, using said trained ML-Model, one or more insights associated with the managing of the items of an inventory, said software agent using said insights to generate an actionable plan for managing, by the user, the inventory of items of the respective source of the multiple distributed sources; and
presenting, to the user, via the chat interface, the actionable plan, the respective source of the multiple distributed sources using the actionable plan to manage its respective inventory of items.

11. The computer system of claim 10, wherein said aggregating said inventory listings of items from the multiple distributed sources comprises:
synchronizing and normalizing said listing of items.

12. The computer system of claim 10, wherein said generated one or more insights associated with the managing of the items of an inventory comprises:
a quality of an inventory mix, said actionable plan comprising an allocation scheme for allocating items as compared to a competitor's allocation of items.

13. The computer system of claim 12, wherein said ML-model is a predictive model configured to predict a duration an item will be purchased based on one or more of: a state of the current market for the item, a pricing of the item, and a historical trend.

14. The computer system of claim 12, wherein said ML-model is a predictive model configured to predict an optimal pricing of said items for consumers to purchase the item.

15. The computer system of claim 12, wherein said ML-model is a predictive model configured to predict a sales forecast for the item.

16. The computer system of claim 12, wherein said ML-model is a predictive model configured to predict a cost for stocking a sales area with an allocation of actual types and amount of items for presentation to consumers within a sales location for the items.

17. The computer system of claim 16, wherein said actionable plan comprises a strategy for stocking an area allocated with an inventory of items that reduce an overall days to sell the item.

18. The computer system of claim 16, wherein said actionable plan comprises: an amount and type of items to order to result in better positioning the user to meet a demand and capture a market share for the items.

19. The computer system of claim 16, wherein said generated insights comprise: a competitor's top-selling items or volume movers, said actionable plan comprising a manner to allocate an inventory mix of items to counter those competitor's top-selling items or volume movers.

20. The computer system of claim 16, wherein said generated insights comprises any trend of sales observed for items for sale by nearby competitors and how said nearby competitors are allocating their inventory of items, and said actionable plan generated based on said insights comprising:
a manner in which a user can one or more of: outsell said nearby competitors of the same items and what strategy to implement that will increase market share for item and outperform sales by said the competitors.

21. A method for managing an inventory of items, the method comprising:
receiving, at a programmed processor, from each of a plurality of multiple distributed sources, a respective listing of an inventory of items;
aggregating, by the programmed processor, each received inventory listings of items from each respective source of the multiple distributed sources;
receiving, from a user, a NL query associated with a managing of the items of an inventory for a respective source of the multiple distributed sources;
accessing, by the programmed processor, a software agent used to interpret the NL query; and
running, by the software agent, in response to the NL query, at least one machine-learned model (ML-model) trained to generate insights regarding the inventory of items received from the respective source;
generating, using said trained ML-Model, one or more insights associated with the managing of the items of an inventory, said software agent using said insights to generate an actionable plan for managing, by the user, the inventory of items of the respective source of the multiple distributed sources; and
presenting, to the user, via the chat interface, the actionable plan, the respective source of the multiple distributed sources using the actionable plan to manage its respective inventory of items.

22. The method of claim 21, wherein said generated one or more insights associated with the managing of the items of an inventory comprises: a quality of an inventory mix resulting from a competitor's allocation of items in a competitor inventory, said method comprising: re-allocating items in the inventory items, based on said inventory mix quality.

23. The method of claim 21, wherein said generated insights comprise: a state of the current market for the item, a pricing of the item, and a historical trend, said ML-model comprising a predictive model configured to predict a duration an item will be purchased based on one or more of said current market state, the item pricing or said historical trend.

24. The method of claim 21, wherein said ML-model is a predictive model configured to predict one or more of: a pricing for consumers to purchase the item, or a sales forecast for the item.

25. The method of claim 21, wherein said ML-model is a predictive model configured to predict a cost for stocking an area allocated with a type and amount of items presented for consumer viewing within a sales location for the items, said method further comprising: stocking an area allocated with an inventory of items that reduce an overall days to sell the item.

26. The method of claim 21, wherein said generated insights comprise: a competitor's top-selling items or volume movers, said actionable plan comprising a manner to allocate an inventory mix of items to counter those competitor's top-selling items or volume movers.

27. The method of claim 26, further comprising: ordering, based on said generated insights, an amount and type of items that result in a better positioning the user to meet a demand and capture a market share for the items.

28. The method of claim 26, wherein said generated insights comprises any trend of sales observed for items for sale by nearby competitors and how said nearby competitors are allocating their inventory of items, and said actionable plan generated based on said insights comprising: a manner in which a user can one or more of: outsell said nearby competitors of the same items and what strategy to implement that will increase market share for item and outperform sales by said the competitors.
